(19) United States
(12) Patent Application Publication
(10) Pub. No.: US 2026/0252647 A1
(43) Pub. Date: Aug. 27, 2026

(54) SYSTEM

(71) Applicant: SoftBank Group Corp., Tokyo (JP)

(72) Inventor: Masatoshi WAKIZAKI, Tokyo (JP)

(73) Assignee: SoftBank Group Corp., Tokyo (JP)

(21) Appl. No.: 19/531,675

(22) Filed: Feb. 6, 2026

(30) Foreign Application Priority Data
Feb. 21, 2025 (JP) 2025-027056

(51) Int. Cl. G06F 16/9535; G06F 16/951; G06F 16/958; G06F 40/166; G06F 40/30; G06N 3/0455; G10L 25/63

(52) U.S. Cl. CPC G06F 16/9535; G06F 16/951; G06F 16/958; G06F 40/166; G06F 40/30; G06N 3/0455; G10L 25/63

(57) ABSTRACT

The system according to the embodiment comprises a data collection unit, a preference analysis unit, a news collection unit, a newsletter generation unit, and a newsletter provision unit. The data collection unit collects user data. The preference analysis unit analyzes the data collected by the data collection unit and identifies user preferences and interests. The news collection unit collects news or articles based on the user's interests obtained by the preference analysis unit. The newsletter generation unit creates a customized newsletter based on the news or articles collected by the news collection unit. The newsletter provision unit provides the newsletter generated by the newsletter generation unit to the user.

### CROSS-REFERENCE TO RELATED APPLICATION

The present application claims priority to and incorporates by reference the entire contents of Japanese Patent Application No. 2025-027056 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, providing customized newsletters based on user interests and preferences has not been sufficiently achieved, and there is room for improvement.

### SUMMARY OF THE INVENTION

The system according to the embodiment comprises a data collection unit, a preference analysis unit, a news collection unit, a newsletter generation unit, and a newsletter provision unit. The data collection unit collects user data. The preference analysis unit analyzes the data collected by the data collection unit and identifies user preferences and interests. The news collection unit collects news or articles based on the user's interests obtained by the preference analysis unit. The newsletter generation unit creates a customized newsletter based on the news or articles collected by the news collection unit. The newsletter provision unit provides the newsletter generated by the newsletter generation unit to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

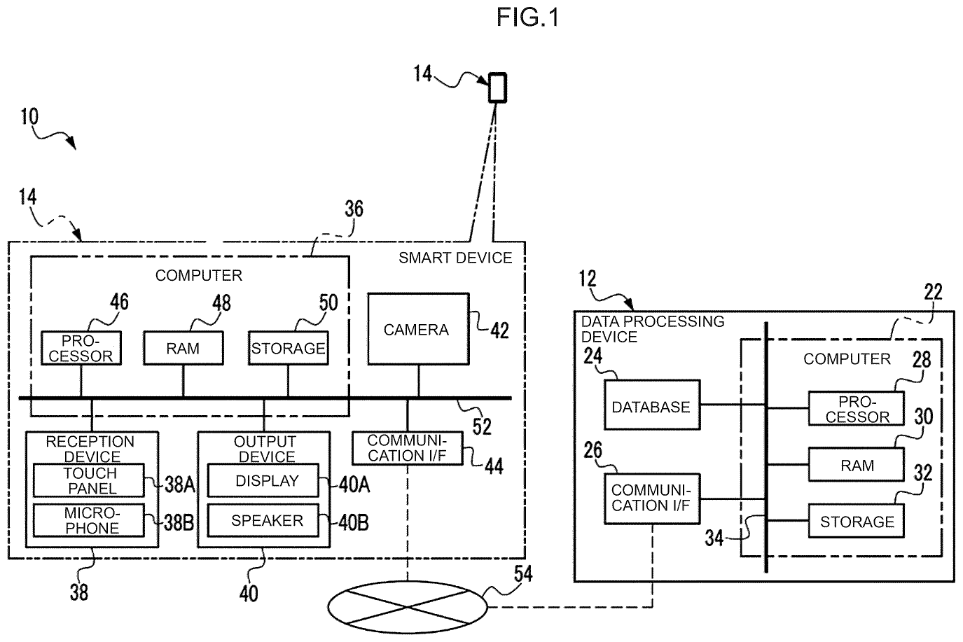

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

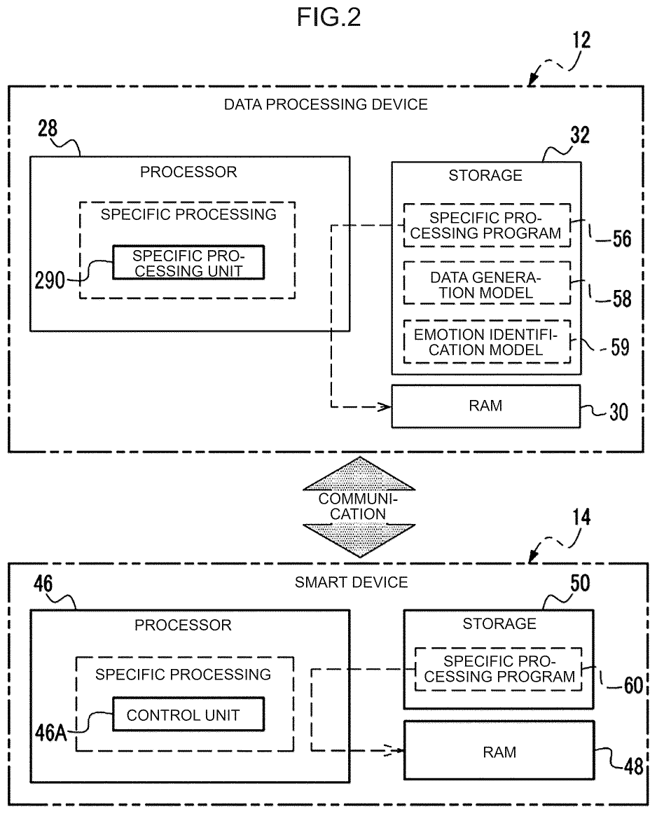

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The AI system according to the embodiment of the present invention is a system that creates a customized newsletter based on the user's interests and preferences. This system analyzes the user's preferences and interests using AI, collects the latest news and interesting articles, and creates a customized newsletter based on the user's interests. Furthermore, the AI summarizes articles using expressions that are likely to go viral and provides them to the user. With this mechanism, users can efficiently obtain news and articles that match their interests, and newsletter providers can fulfill users' desire for virality while guiding them to specific platforms to read the original articles. For example, the AI analyzes the user's preferences and interests. In this process, data such as the user's past browsing history, search history, and activity on social media are collected and analyzed by the AI. For instance, by analyzing the categories of news frequently browsed by the user and the tendencies of articles shared on social media, the user's interests can be identified. Next, the AI collects the latest news and interesting articles. The AI collects the latest information from news sites, blogs, and social media on the Internet and filters it based on the user's interests. For example, if the user is interested in technology, the AI prioritizes the collection of the latest news and articles related to technology. Based on the collected news and articles, the AI creates a customized newsletter. The AI selects articles that match the user's interests and summarizes them using expressions that are likely to go viral. For example, the AI changes the article titles and lead sentences to catchy expressions to attract the user's attention. Finally, the AI provides the created newsletter to the user. The newsletter includes links to the original articles, and by clicking on articles of interest, the user is guided to a specific platform. With this mechanism, newsletter providers can fulfill users' desire for virality while guiding them to specific platforms to read the original articles. Thus, the AI system can efficiently provide customized newsletters based on the user's interests and preferences. Specifically, this AI system obtains the user's behavioral data (e.g., browsing history for the past 30 days as a time-series tensor (e.g., 1000×24 dimensions), search history as a keyword vector (e.g., 500 dimensions), social media activity as a text array of posts and numerical series of shares/likes) via the data collection unit, preprocesses the data (e.g., tokenization by natural language processing, category classification, time-series normalization), and inputs it to the preference analysis unit. The preference analysis unit uses, for example, a multilayer perceptron or a Transformer-based large language model to output the user's interest categories (e.g., technology, sports, entertainment, etc.) as a probability distribution (e.g., category scores: technology 0.8, sports 0.1, etc.). Example outputs include “User A's interest distribution: technology 0.7, entertainment 0.2, politics 0.1” and “User B's interest distribution: sports 0.6, health 0.3, economy 0.1”. The news collection unit uses these interest distributions as input and collects a large amount of news article data (e.g., structured data including title, body, publication date, source, category label, etc.) using web scraping or RSS feed APIs, and performs filtering based on interest categories (e.g., extracting only those with category scores of 0.5 or higher). Furthermore, the newsletter generation unit inputs the collected article bodies to a summarization generation model (e.g., Encoder-Decoder type Transformer, BART, etc.) to automatically generate expressions likely to go viral (e.g., catchy title generation, lead sentence generation likely to spread on SNS). Example inputs include “original article body (1000 characters)”, and example outputs include “summary title: ‘Hot AI technologies: 5 ways to change your life’” and “summary body: ‘Explaining how the latest AI technologies are affecting daily life.’”. The generated newsletter is delivered to the user's email address or app notification destination by the newsletter provision unit, and URL links or QR codes to the original articles are automatically inserted. As a subsequent process, the data collection unit again obtains behavioral logs such as articles clicked by the user and the time of opening, and uses them to improve personalization accuracy in future iterations. As a technical effect, this AI system can analyze vast amounts of data quickly and with high accuracy, and generate and provide optimized newsletters for each user in real time, compared to manual article selection, summarization, and delivery by humans, thereby achieving remarkable effects such as improved efficiency and accuracy of information provision, increased user satisfaction, and higher platform guidance rates. Application fields include news distribution services, automatic generation of internal company newsletters, distribution of learning materials in the education field, and personalized advertising distribution in marketing, among many other use cases.

The AI system according to the embodiment comprises a data collection unit, a preference analysis unit, a news collection unit, a newsletter generation unit, and a newsletter provision unit. The data collection unit collects user data. User data may include, for example, browsing history, search history, and activity data on social media, but is not limited thereto. The data collection unit may collect the user's past browsing history and obtain browsing data within a specific period. The data collection unit may also collect the user's search history and obtain data based on specific search engines or keywords. Furthermore, the data collection unit may collect activity data on social media, such as the user's posts, likes, and shares. The preference analysis unit analyzes the data collected by the data collection unit to identify the user's preferences and interests. For example, the preference analysis unit may analyze the user's browsing history to identify interests in specific news categories or topics. The preference analysis unit may also analyze the user's search history to identify interests based on specific keywords or search patterns. Furthermore, the preference analysis unit may analyze activity data on social media to identify interests based on the tendency of articles shared by the user or the content of accounts followed. The news collection unit collects news or articles based on the user's interests obtained by the preference analysis unit. For example, the news collection unit collects the latest information from news sites, blogs, or social media on the Internet. The news collection unit may collect the latest news from specific news sites or blogs and filter them based on the user's interests. The news collection unit may also collect the latest posts from social media and filter them based on the user's interests. The newsletter generation unit creates a customized newsletter based on the news or articles collected by the news collection unit. For example, the newsletter generation unit selects articles that match the user's interests and summarizes them using expressions that attract the user's attention. The newsletter generation unit may change the article titles and lead sentences to catchy expressions to attract the user's interest. The newsletter generation unit may also summarize the article content concisely so that the user can quickly grasp the content. The newsletter provision unit provides the newsletter generated by the newsletter generation unit to the user. For example, the newsletter provision unit provides the generated newsletter to the user via methods such as email delivery or app notifications. The newsletter provision unit includes links to the original articles in the newsletter, allowing the user to be guided to a specific platform by clicking on articles of interest. Thus, the AI system according to the embodiment can efficiently provide customized newsletters based on the user's interests and preferences. Some or all of the above-described processing in the newsletter provision unit may be performed using AI, or may be performed without using AI. For example, the newsletter provision unit can input the generated newsletter to an AI model and have the AI execute the optimal provision method. Specifically, this AI system collects the user's behavioral data (e.g., browsing history for the past 30 days as a 1000×24-dimensional time-series tensor, search history as a 500-dimensional keyword vector, social media activity as a text array of posts and numerical series of shares/likes), applies preprocessing such as tokenization by natural language processing, category classification, and time-series normalization, and inputs the data to the preference analysis unit. The preference analysis unit uses a multilayer perceptron or Transformer-based large language model to output the user's interest categories (e.g., technology, sports, entertainment, etc.) as category scores (e.g., technology 0.8, sports 0.1, etc.). Example inputs include “user A's browsing history tensor,” “search keyword vector,” and “SNS post text array,” and example outputs include “interest distribution: technology 0.7, entertainment 0.2, politics 0.1,” etc. The news collection unit uses these interest distributions as input and collects a large amount of news article data (title, body, publication date, source, category label, etc.) using web scraping or RSS feed APIs, and performs filtering based on interest categories (extracting only those with category scores of 0.5 or higher). The newsletter generation unit inputs the collected article bodies to a summarization generation model such as Encoder-Decoder type Transformer or BART to automatically generate catchy titles and lead sentences likely to spread on SNS. Example inputs include “original article body (1000 characters),” and example outputs include “summary title: ‘Hot AI technologies: 5 ways to change your life’” and “summary body: ‘Explaining how the latest AI technologies are affecting daily life.’”. The newsletter provision unit delivers the generated newsletter to the user's email address or app notification destination and automatically inserts URL links or QR codes to the original articles. As a subsequent process, the data collection unit again obtains behavioral logs such as articles clicked by the user and the time of opening, and uses them to improve personalization accuracy in future iterations. As a technical effect, this AI system can analyze vast amounts of data quickly and with high accuracy, and generate and provide optimized newsletters for each user in real time, compared to manual article selection, summarization, and delivery by humans, thereby achieving remarkable effects such as improved efficiency and accuracy of information provision, increased user satisfaction, and higher platform guidance rates. Application fields include news distribution services, automatic generation of internal company newsletters, distribution of learning materials in the education field, and personalized advertising distribution in marketing, among many other use cases.

The data collection unit can collect a user's past browsing history, search history, and activity data on social media. For example, the data collection unit collects the user's past browsing history. The past browsing history may include browsing data within a specific period, but is not limited thereto. The data collection unit collects browsing history of specific sites or pages and can identify the user's interests. The data collection unit also collects the user's search history. The search history may include search data based on specific search engines or keywords, but is not limited thereto. The data collection unit analyzes specific keywords or search patterns to identify the user's interests. Furthermore, the data collection unit collects activity data on social media. Activity data on social media may include the user's posts, likes, and shares, but is not limited thereto. The data collection unit analyzes the user's activity on social media to identify interests. By collecting the user's past behavioral data, more accurate preference analysis becomes possible. Some or all of the above-described processing in the data collection unit may be performed using AI, or may be performed without using AI. For example, the data collection unit can input the user's past browsing history to AI and have the AI perform analysis to identify interests. Specifically, this data collection unit obtains the user's browsing history for the past 30 days as a time-series tensor (e.g., 1000×24 dimensions, each element including page ID, category label, and browsing time), collects search history as a keyword vector (e.g., 500 dimensions, each element representing keyword frequency or TF-IDF value), and structures social media activity as a post text array (e.g., 20 posts per day, each post up to 500 tokens of natural language text) and numerical series of likes and shares (e.g., number of actions per day). The data collection unit applies preprocessing such as tokenization by natural language processing, category classification, and time-series normalization, and automatically performs missing value imputation and outlier removal. Furthermore, the data collection unit dynamically optimizes the data acquisition frequency and target sites for each user by referring to past collection history and user usage trends to determine the priority of collection targets. When using AI, for example, Transformer-based large language models or multilayer perceptrons are utilized, with input data such as “browsing history tensor,” “search keyword vector,” and “SNS post text array,” and output such as “score distribution for each interest category” or “candidate list for next collection targets.” Example inputs include “browsing history from May 1 to May 30, 2024 (1000 items×24 dimensions),” “search keyword vector for the past 30 days (500 dimensions),” and “20 SNS post texts,” and example outputs include “interest categories: technology 0.8, sports 0.1, entertainment 0.1” or “next collection targets: news site A, blog B, SNS account C.” These outputs are used as input for subsequent preference analysis units and news collection units, realizing an optimized data flow for each user. As a technical effect, this data collection unit can acquire and preprocess vast amounts of data quickly and with high accuracy compared to manual data collection and organization by humans, thereby achieving remarkable effects such as improved personalization accuracy, data management efficiency, and overall system response speed. Application fields include news distribution services, personalized advertising, learning history analysis in education, behavioral monitoring in healthcare, and many other use cases.

The preference analysis unit can analyze the data collected by the data collection unit to identify the user's interests. For example, the preference analysis unit analyzes the user's browsing history collected by the data collection unit. The browsing history may include browsing data within a specific period, but is not limited thereto. The preference analysis unit can identify interests in specific news categories or topics. The preference analysis unit also analyzes the user's search history collected by the data collection unit. The search history may include search data based on specific search engines or keywords, but is not limited thereto. The preference analysis unit analyzes specific keywords or search patterns to identify the user's interests. Furthermore, the preference analysis unit analyzes activity data on social media collected by the data collection unit. Activity data on social media may include the user's posts, likes, and shares, but is not limited thereto. The preference analysis unit can identify interests based on the tendency of articles shared by the user or the content of accounts followed. By accurately identifying the user's interests, the accuracy of customized newsletters is improved. Some or all of the above-described processing in the preference analysis unit may be performed using AI, or may be performed without using AI. For example, the preference analysis unit can input the user's browsing history to AI and have the AI perform analysis to identify interests. Specifically, this preference analysis unit receives the user's browsing history tensor from the data collection unit (e.g., 1000×24 dimensions, each element including page ID, category label, and browsing time), search history keyword vector (e.g., 500 dimensions, each element representing keyword frequency or TF-IDF value), and social media activity data (e.g., post text array and numerical series of shares/likes) as input data. The preference analysis unit performs preprocessing such as tokenization by natural language processing, category classification, time-series normalization, feature extraction (e.g., embedding vectorization by BERT or Word2Vec), and outlier removal or missing value imputation. Next, the preference analysis unit uses, for example, a multilayer perceptron or Transformer-based large language model to estimate the user's interest categories. The model architecture concatenates the browsing history tensor, search keyword vector, and embedding vectors of social media posts at the input layer, passes them through multiple self-attention layers and fully connected layers, and generates a score distribution for each category (e.g., technology 0.7, entertainment 0.2, politics 0.1) at the output layer. Example inputs include “browsing history from May 1 to May 30, 2024 (1000 items×24 dimensions),” “search keyword vector for the past 30 days (500 dimensions),” and “20 SNS post texts,” and example outputs include “interest categories: technology 0.8, sports 0.1, entertainment 0.1” or “interest categories: health 0.6, economy 0.3, politics 0.1.” The preference analysis unit passes these outputs to subsequent news collection units and newsletter generation units to realize optimized newsletter generation for each user. Furthermore, the preference analysis unit can track changes in the user's interests over time by combining recurrent neural networks or time-series autoregressive models to predict trends and transitions in interests. For AI model training, cross-entropy loss functions and regularization terms are used, and supervised learning is performed on large datasets using parallel computing clusters with GPUs. Thus, unlike conventional simple rule-based or manual analysis, complex pattern extraction in high-dimensional feature spaces and nonlinear interest estimation are possible, enabling fine-grained personalization for each user. As a technical effect, this preference analysis unit can analyze vast behavioral data quickly and with high accuracy, and grasp the user's interests in real time, thereby achieving remarkable effects such as improved personalization accuracy of newsletters, efficiency of information provision, increased user satisfaction, and improved overall system response speed. Application fields include news distribution services, personalized advertising, learning history analysis in education, behavioral monitoring in healthcare, and many other use cases.

The news collection unit can collect the latest information from news sites, blogs, or social media on the Internet. For example, the news collection unit collects the latest news from news sites on the Internet. News sites may include the latest information on specific news categories or topics, but are not limited thereto. The news collection unit collects the latest news from specific news sites and can filter them based on the user's interests. The news collection unit also collects the latest information from blogs on the Internet. Blogs may include the latest information on specific topics, but are not limited thereto. The news collection unit collects the latest information from specific blogs and can filter them based on the user's interests. Furthermore, the news collection unit collects the latest posts from social media. Social media may include articles shared by users and post content, but are not limited thereto. The news collection unit collects the latest posts from social media and can filter them based on the user's interests. By collecting the latest information, timely news can be provided to the user. Some or all of the above-described processing in the news collection unit may be performed using AI, or may be performed without using AI. For example, the news collection unit can input news collected from news sites on the Internet to AI and have the AI perform filtering. Specifically, this news collection unit uses web scraping modules or RSS feed APIs to obtain article data from news sites and blogs in structured formats (e.g., database records including title, body, publication date, source, and category label) in large quantities. From social media, post data (e.g., post body text, poster ID, number of shares, number of likes, posting time, etc.) is collected via API. These data are preprocessed immediately after collection by natural language processing for tokenization, language detection, duplicate removal, spam detection, and category classification. When using AI, for example, Transformer-based large language models or convolutional neural networks are utilized, with input such as “article body text (up to 2000 tokens),” “category label,” and “post metadata (publication date, source, etc.),” and output such as “relevance score for each user interest category (e.g., technology 0.8, entertainment 0.1, sports 0.1)” or “priority label for collected articles (high, medium, low).” Example inputs include “title: Latest trends in AI technology, body: Explanation of AI industry trends in 2024, category: technology” or “post body: New smartphone released, number of shares: 500,” and example outputs include “relevance score: technology 0.9, entertainment 0.05, sports 0.05” or “priority: high.” The news collection unit uses these outputs to compare with the user's interest distribution (e.g., category scores obtained from the preference analysis unit) and performs filtering such as extracting only news with category scores of 0.5 or higher. Furthermore, the news collection unit can evaluate the reliability of collected articles (e.g., source reliability score, author's past achievements, output of fake news detection models) and exclude articles with low reliability. For AI model training, supervised learning datasets (e.g., correspondence between past user click history and article categories) are used, cross-entropy loss functions and regularization terms are applied, and large-scale parallel learning is performed on GPU clusters. Thus, unlike conventional simple keyword matching or manual article selection, complex pattern extraction in high-dimensional feature spaces and nonlinear relevance estimation are possible. As a technical effect, this news collection unit can extract optimized news for each user quickly and with high accuracy from vast information on the web, thereby achieving remarkable effects such as improved real-time information provision, reduction of noise data, increased user satisfaction, and improved scalability of the entire system. Application fields include news distribution services, personalized advertising, automatic generation of internal company newsletters, collection of educational materials in the education field, collection of the latest papers in healthcare, and many other use cases.

The newsletter generation unit can select articles that match the user's interests and summarize them using expressions that attract the user's attention. For example, the newsletter generation unit selects articles that match the user's interests. Articles that match the user's interests may include articles on specific topics or genres, but are not limited thereto. The newsletter generation unit can select articles on specific topics or genres and summarize them using expressions that attract the user's attention. The newsletter generation unit may also change the article titles and lead sentences to catchy expressions to attract the user's interest. For example, the newsletter generation unit summarizes the article content concisely so that the user can quickly grasp the content. By summarizing using expressions likely to go viral, the user's interest is more easily attracted. Some or all of the above-described processing in the newsletter generation unit may be performed using AI, or may be performed without using AI. For example, the newsletter generation unit can input articles that match the user's interests to AI and have the AI perform summarization. Specifically, the newsletter generation unit receives article body data from the news collection unit (e.g., up to 2000 tokens of natural language text, including title, publication date, category label, etc.) and the user's interest category distribution (e.g., score vector such as technology 0.7, entertainment 0.2, sports 0.1) as input. The newsletter generation unit first tokenizes the article body using a natural language processing module and performs key phrase extraction and sentence segmentation. Next, the user's interest categories and article category labels are matched, and articles with high category scores are preferentially selected. The selected article bodies are input to a summarization generation model using an Encoder-Decoder type Transformer architecture (e.g., BART or T5). Example inputs include “title: Latest trends in AI technology, body: Explanation of AI industry trends in 2024, category: technology” or “title: New movie review, body: Introduction of highlights of a trending movie, category: entertainment.” The summarization generation model outputs, for example, “summary title: ‘Hot AI technologies: 5 ways to change your life,’” “summary body: ‘Explaining how the latest AI technologies are affecting daily life,’” or “summary title: ‘Must-see! Top 3 trending movies of the year,’” automatically generating catchy expressions likely to go viral. Furthermore, the newsletter generation unit may apply additional natural language generation modules to add lead sentences likely to spread on SNS or emotional expressions (e.g., “Surprising latest information for you!”) to the generated summary text. For AI model training, past SNS diffusion results and click-through rate data are used as training data, and optimization is performed using cross-entropy loss functions and label smoothing. The output summary text is passed to the newsletter provision unit and used as the body of emails or app notifications. As a subsequent process, the data collection unit again obtains behavioral logs such as summary titles clicked by the user and the time of opening, and uses them to improve the personalization accuracy of the summarization generation model in future iterations. As a technical effect, the newsletter generation unit can analyze vast amounts of article data quickly and with high accuracy compared to manual article selection, summarization, and expression crafting by humans, and generate optimized viral summary texts for each user in real time, thereby achieving remarkable effects such as improved efficiency of information provision, improved summarization accuracy, increased user satisfaction, and increased click-through and diffusion rates. Application fields include news distribution services, automatic generation of internal company newsletters, summarization of learning materials in education, personalized advertising summarization in marketing, and trend summary distribution for SNS, among many other use cases.

The newsletter provision unit can provide the generated newsletter to the user and include links to the original articles. For example, the newsletter provision unit provides the generated newsletter to the user. The newsletter provision unit can provide the generated newsletter to the user via methods such as email delivery or app notifications. Additionally, the newsletter provision unit includes links to the original articles in the newsletter. The links to the original articles may include URL links or QR codes, but are not limited thereto. The newsletter provision unit can guide the user to a specific platform by allowing the user to click on articles of interest. Thus, by including links to the original articles, the user can be guided to a specific platform. Some or all of the above-described processing in the newsletter provision unit may be performed using AI, or may be performed without using AI. For example, the newsletter provision unit can input the generated newsletter to AI and have the AI execute the optimal provision method. Specifically, the newsletter provision unit receives the summarized newsletter body from the newsletter generation unit (e.g., structured data including title, summary body, original article URL, category label, etc.) and user delivery destination information (e.g., email address, app ID, device type, etc.) as input. The newsletter provision unit first uses a delivery channel selection module to refer to the user's past browsing history and device usage trends to determine the optimal delivery method (e.g., email, app notification, web push notification, etc.). Next, a URL link or QR code generation module is applied to the newsletter body, and links or QR code images are automatically inserted into the body. When using AI, for example, a multilayer perceptron or reinforcement learning-based delivery optimization model is utilized, with input such as “newsletter body,” “user's past click history,” and “candidate delivery channel list,” and output such as “optimal delivery channel (e.g., app notification),” “delivery timing (e.g., 6:00 PM on weekdays),” or “link insertion position (e.g., immediately below the title).” Example inputs include “title: Hot AI technologies, body: Latest AI technologies are changing lives, URL: https://example.com/article/123” or “delivery destination: userA@example.com, device: smartphone,” and example outputs include “delivery method: app notification, delivery time: 19:00, link insertion: end of body” or “delivery method: email, QR code insertion: below title.” The newsletter provision unit performs the actual delivery processing based on these outputs and feeds back user click logs and open logs to the data collection unit after delivery. As a subsequent process, behavioral data such as articles clicked by the user and the time of opening are collected again and used to optimize future delivery and improve personalization accuracy. As a technical effect, the newsletter provision unit can analyze vast user data quickly and with high accuracy compared to manual selection of delivery channels, link insertion, and delivery timing adjustment by humans, and determine and execute the optimal delivery method, link insertion, and timing for each user in real time, thereby achieving remarkable effects such as improved efficiency of information provision, improved delivery accuracy, increased user satisfaction, and higher platform guidance rates. Application fields include news distribution services, personalized advertising delivery, distribution of educational materials in education, automatic delivery of internal company newsletters, event information delivery, and many other use cases.

The data collection unit can estimate the user's emotions and adjust the timing of data collection based on the estimated emotions. For example, the data collection unit estimates the user's emotions. The user's emotions may include stress, relaxation, excitement, etc., but are not limited thereto. The data collection unit can estimate emotions using technologies such as facial expression recognition and text analysis. The data collection unit also adjusts the timing of data collection based on the estimated emotions. For example, if the user is feeling stressed, the frequency of data collection can be reduced to lessen the user's burden. If the user is relaxed, the frequency of data collection can be increased to collect more detailed data. Furthermore, if the user is excited, data can be collected in real time and reflected immediately. Thus, by adjusting the timing of data collection according to the user's emotions, the user's burden can be reduced. Emotion estimation may be realized using emotion engines or generative AI, for example, by using emotion estimation functions. Generative AI may include text generation AI (e.g., LLM) or multimodal generative AI, but is not limited thereto. Some or all of the above-described processing in the data collection unit may be performed using AI, or may be performed without using AI. For example, the data collection unit can input the user's facial expression data to generative AI and have the generative AI perform emotion estimation. Specifically, this data collection unit simultaneously obtains the user's facial image data (e.g., face image tensor 224×224×3, 30 frames per second), audio data (e.g., 5 seconds of audio waveform, 16 kHz sampling), and text data (e.g., SNS posts or chat history, up to 512 tokens), and normalizes and extracts features using a multimodal preprocessing module. Facial images are encoded using a CNN-based facial expression recognition model (e.g., ResNet-50), audio is converted to a spectrogram and emotion features are extracted using RNN or Transformer, and text is converted to emotion embedding vectors using a pretrained language model such as BERT. These features are integrated and input to a multimodal emotion estimation model (e.g., Late Fusion-type Transformer) to obtain outputs such as “emotion label (e.g., stress, relaxation, excitement)” and “emotion intensity score (e.g., stress 0.7, relaxation 0.2, excitement 0.1).” Example inputs include “sequence of face image frames+audio waveform+text such as ‘I was busy and tired today’,” and example outputs include “emotion label: stress, intensity 0.8” or “emotion label: relaxation, intensity 0.6.” The data collection unit uses these emotion estimation results to determine dynamic collection intervals in the data collection frequency control module, such as “every 10 minutes under normal conditions, every 60 minutes under stress, every 1 minute under excitement,” and reflects them in the actual data collection scheduler. For AI model training, multimodal datasets with emotion annotations are used, cross-entropy loss functions and multitask learning are applied, and large-scale parallel learning is performed on GPU clusters. As a subsequent process, the history of estimated emotions and collection timing is recorded and used for future model optimization and personalization for each user. As a technical effect, this data collection unit can analyze vast multimodal data quickly and with high accuracy compared to subjective judgment by humans to adjust collection timing, and can obtain necessary data at optimal timing while minimizing the user's psychological burden, thereby achieving remarkable effects such as improved personalization accuracy, enhanced user experience, and overall system efficiency. Application fields include personalized news distribution, stress monitoring in healthcare, learning status tracking in education, and emotion response analysis in marketing, among many other use cases.

The data collection unit can analyze the user's past data collection history and select an appropriate collection method. For example, the data collection unit analyzes the user's past data collection history. The past data collection history may include data collection history within a specific period, but is not limited thereto. The data collection unit analyzes specific data collection history and can select the optimal collection method. The data collection unit can also preferentially collect data sources that the user has frequently accessed in the past. For example, the data collection unit can optimize the data collection method by considering devices and applications previously used by the user. Furthermore, the data collection unit can analyze the user's past data collection patterns and collect data at optimal timing. Thus, by analyzing past data collection history, the optimal collection method can be selected. Some or all of the above-described processing in the data collection unit may be performed using AI, or may be performed without using AI. For example, the data collection unit can input the user's past data collection history to AI and have the AI select the optimal collection method. Specifically, this data collection unit records and manages “past 30 days of data collection history” for each user as a time-series tensor (e.g., 1000 items×10 dimensions, each element including collection date/time, collection target, device type, collection success/failure flag, collection duration, user response (e.g., click presence), collection source ID, etc.). The data collection unit inputs these history data to a time-series analysis module and uses autoregressive models or LSTM-type recurrent neural networks to extract collection patterns for each user (e.g., frequent collection from smartphones at night on weekdays, high collection success rate when using specific apps, etc.). Furthermore, clustering algorithms (e.g., K-means) and association rule mining are applied to automatically extract features such as “high-frequency access sources,” “devices with many collection failures,” and “time periods with good user response” from the collection history. When using AI, a Transformer-based history pattern analysis model is used, with “collection history tensor” as input and outputs such as “recommended collection method (e.g., device A+app B+nighttime),” “collection frequency (e.g., 3 times per day),” and “priority source list (e.g., news site X, SNS account Y).” Example inputs include “collection history tensor from May 1 to May 30, 2024,” “device usage history vector,” and “user response series,” and example outputs include “recommended method: smartphone+app B, frequency: twice a day,” “priority sources: news site X, SNS account Y.” These outputs are reflected in the actual data collection scheduler and collection target selection module, realizing an optimized data collection flow for each user. For AI model training, past collection history, collection success rate, and user response data are used as training data, cross-entropy loss functions and time-series regularization are applied, and large-scale parallel learning is performed on GPU clusters. As a technical effect, this data collection unit can analyze vast history data quickly and with high accuracy compared to selection of collection methods based on human experience, and can automatically determine the optimal collection method, timing, and targets for each user, thereby achieving remarkable effects such as improved collection efficiency, data quality, and overall system response speed. Application fields include personalized news distribution, behavioral monitoring in healthcare, learning history analysis in education, and data collection optimization for IoT devices, among many other use cases.

The data collection unit can perform filtering during data collection based on the user's current interests and activity status. For example, the data collection unit identifies the user's current interests and activity status during data collection. Current interests and activity status may include real-time search keywords and currently viewed pages, but are not limited thereto. The data collection unit performs filtering based on the user's current interests and activity status. For example, the data collection unit can preferentially collect data related to topics the user is currently interested in. The data collection unit can also filter and collect data related to the user's current activities. Furthermore, the data collection unit can exclude unnecessary data and collect data based on the user's current interests. Thus, by performing filtering based on current interests and activity status, highly relevant data can be collected. Some or all of the above-described processing in the data collection unit may be performed using AI, or may be performed without using AI. For example, the data collection unit can input the user's current interests and activity status to AI and have the AI perform filtering. Specifically, this data collection unit collects the user's real-time behavioral data (e.g., current browsing page URL, active search keyword vector (e.g., 20 dimensions), application usage status, current location information, recent SNS post content, etc.) and structures them as time-series tensors or category vectors. The data collection unit tokenizes search keywords and browsing page titles using a natural language processing module and estimates “current interest categories (e.g., technology, sports, entertainment, etc.)” using a category classification model (e.g., BERT-based classifier). Furthermore, the user's activity log (e.g., app launch history, click event series) is analyzed to determine the current activity status (e.g., browsing news, watching videos, posting on SNS, etc.). When using AI, a Transformer-based multimodal classification model is used, with “search keyword vector,” “browsing page title,” and “activity log” as input, and outputs such as “current interest category score (e.g., technology 0.9, sports 0.05, entertainment 0.05)” and “priority collection target list (e.g., technology-related news, latest gadget information).” Example inputs include “search keyword: AI technology, browsing page: latest smartphone review, activity: browsing news,” and example outputs include “priority category: technology, priority collection: AI-related news.” The data collection unit uses these outputs to perform filtering of collection target data (e.g., excluding data with interest category scores below 0.5) and prioritization of collection, suppressing the collection of unnecessary data. For AI model training, past user behavior and corresponding interest category data are used as training data, cross-entropy loss functions and category balance adjustment are applied, and large-scale parallel learning is performed on GPU clusters. As a technical effect, this data collection unit can analyze vast real-time data quickly and with high accuracy compared to manual determination of interests and selection of collection targets by humans, and efficiently collect only highly relevant data optimized for each user, thereby achieving remarkable effects such as reduction of information noise, improved personalization accuracy, and overall system efficiency. Application fields include personalized news distribution, ad targeting, learning status tracking in education, and real-time behavioral monitoring in healthcare, among many other use cases.

The data collection unit can estimate the user's emotions and determine the priority of data to be collected based on the estimated emotions. For example, the data collection unit estimates the user's emotions. The user's emotions may include stress, relaxation, excitement, etc., but are not limited thereto. The data collection unit can estimate emotions using technologies such as facial expression recognition and text analysis. The data collection unit also determines the priority of data to be collected based on the estimated emotions. For example, if the user is feeling stressed, content that helps relaxation can be preferentially collected. If the user is relaxed, interesting news and articles can be preferentially collected. Furthermore, if the user is excited, highly entertaining content can be preferentially collected. Thus, by determining the priority of data to be collected according to the user's emotions, more appropriate data can be collected. Emotion estimation may be realized using emotion engines or generative AI, for example, by using emotion estimation functions. Generative AI may include text generation AI (e.g., LLM) or multimodal generative AI, but is not limited thereto. Some or all of the above-described processing in the data collection unit may be performed using AI, or may be performed without using AI. For example, the data collection unit can input the user's facial expression data to generative AI and have the generative AI perform emotion estimation. Specifically, this data collection unit simultaneously obtains the user's facial image data (e.g., face image tensor 224×224×3, 30 frames per second), audio data (e.g., 5 seconds of audio waveform, 16 kHz sampling), and text data (e.g., SNS posts or chat history, up to 512 tokens), and normalizes and extracts features using a multimodal preprocessing module. Facial images are encoded using a convolutional neural network (e.g., ResNet-50), audio is converted to a spectrogram and emotion features are extracted using a recurrent neural network or Transformer, and text is converted to emotion embedding vectors using a pretrained language model (e.g., BERT). These features are integrated and input to a multimodal emotion estimation model (e.g., Late Fusion-type Transformer) to obtain outputs such as “emotion label (e.g., stress, relaxation, excitement)” and “emotion intensity score (e.g., stress 0.7, relaxation 0.2, excitement 0.1).” Example inputs include “sequence of face image frames+audio waveform+text such as ‘I was busy and tired today’,” and example outputs include “emotion label: stress, intensity 0.8” or “emotion label: relaxation, intensity 0.6.” The data collection unit uses these emotion estimation results in the data collection priority determination module to dynamically assign priorities such as “relaxation content prioritized during stress, intellectually curious news prioritized during relaxation, entertainment content prioritized during excitement,” and reflects them in the actual data collection scheduler and collection target selection module. For AI model training, multimodal datasets with emotion annotations are used, cross-entropy loss functions and multitask learning are applied, and large-scale parallel learning is performed on GPU clusters. As a subsequent process, the history of estimated emotions and collection priorities is recorded and used for future model optimization and personalization for each user. As a technical effect, this data collection unit can analyze vast multimodal data quickly and with high accuracy compared to subjective judgment by humans to determine collection priorities, and realize data collection optimized for the user's psychological state, thereby achieving remarkable effects such as improved personalization accuracy, enhanced user experience, and overall system efficiency. Application fields include personalized news distribution, stress monitoring in healthcare, learning status tracking in education, and emotion response analysis in marketing, among many other use cases.

The data collection unit can preferentially collect highly relevant data during data collection by considering the user's geographic location information. For example, the data collection unit considers the user's geographic location information during data collection. Geographic location information may include GPS data or IP addresses, but is not limited thereto. The data collection unit preferentially collects highly relevant data based on the user's geographic location information. For example, the data collection unit can preferentially collect news or information related to the region where the user is currently located. The data collection unit can also collect local event or weather information based on the user's geographic location. Furthermore, the data collection unit can preferentially collect region-specific topics by considering the user's location information. Thus, by considering geographic location information, region-specific highly relevant data can be collected. Some or all of the above-described processing in the data collection unit may be performed using AI, or may be performed without using AI. For example, the data collection unit can input the user's geographic location information to AI and have the AI perform collection of highly relevant data. Specifically, this data collection unit obtains the user's GPS coordinates (e.g., latitude and longitude as a 2-dimensional vector), region code estimated from IP address, and Wi-Fi access point information in real time, and standardizes them using a geographic information normalization module. Geographic location information is matched with a map database or regional category dictionary and converted to category labels such as “prefecture,” “city/ward/town/village,” or “landmark.” The data collection unit uses these geographic features as input to dynamically select region-specific data collection algorithms (e.g., local news API, regional event calendar API, weather information API) and calculates a regional relevance score (e.g., 0.0 to 1.0). When using AI, a multilayer perceptron or Transformer-based geographic information relevance estimation model is used, with “GPS vector,” “region category,” and “user's past region-specific interest distribution” as input, and outputs such as “priority collection categories (e.g., local news, regional events, weather information)” and “collection priority score.” Example inputs include “GPS: 35.6895,139.6917 (central Tokyo),” “IP: xxx.xxx.xxx.xxx (Osaka City),” and example outputs include “priority categories: Tokyo events, weather information, regional news.” The data collection unit uses these outputs to perform filtering and prioritization of collection target data, efficiently collecting region-specific information. For AI model training, past region-specific user behavior data and click history are used as training data, cross-entropy loss functions and geographic balance adjustment are applied, and large-scale parallel learning is performed on GPU clusters. As a technical effect, this data collection unit can analyze vast geographic data quickly and with high accuracy compared to manual determination of regional information and selection of collection targets by humans, and efficiently collect only region-specific data optimized for each user, thereby achieving remarkable effects such as reduction of information noise, improved personalization accuracy, and overall system efficiency. Application fields include personalized news distribution, region-focused advertising, tourism information provision, disaster information distribution, local event guidance, and many other use cases.

The data collection unit can analyze the user's social media activity during data collection and collect relevant data. For example, the data collection unit analyzes the user's social media activity during data collection. Social media activity may include post content, likes, shares, etc., but is not limited thereto. The data collection unit analyzes the user's social media activity and collects relevant data. For example, the data collection unit can collect data related to articles shared by the user on social media. The data collection unit can also analyze the content of posts from accounts followed by the user and collect relevant data. Furthermore, the data collection unit can collect data that the user is likely to be interested in based on the user's social media activity history. Thus, by analyzing social media activity, data related to the user's interests can be collected. Some or all of the above-described processing in the data collection unit may be performed using AI, or may be performed without using AI. For example, the data collection unit can input the user's social media activity to AI and have the AI perform collection of relevant data. Specifically, this data collection unit obtains the user's SNS post text (e.g., 20 posts per day, each post up to 500 tokens), numerical series of likes and shares (e.g., number of actions per day), and list of followed accounts (e.g., up to 1000 accounts) via API, and performs tokenization, category classification, and sentiment analysis using a natural language processing module. Post content is vectorized using BERT or Word2Vec, and action series are normalized as time series. The data collection unit uses these features as input to a social graph analysis module or clustering algorithm (e.g., K-means) to extract the user's interest clusters and trending topics. When using AI, a Transformer-based multimodal classification model is used, with “post text vector,” “action series,” and “followed account features” as input, and outputs such as “priority collection categories (e.g., technology, entertainment, sports),” “relevance score,” and “recommended collection target list (e.g., news related to shared articles, new articles from followed authors).” Example inputs include “post: AI technology is interesting, number of shares: 10, followed: technology-related accounts,” and example outputs include “priority category: technology, recommended collection: AI-related news.” The data collection unit uses these outputs to perform filtering and prioritization of collection target data, realizing data collection optimized for the user's interests. For AI model training, past SNS behavior and corresponding click history/interest category data are used as training data, cross-entropy loss functions and category balance adjustment are applied, and large-scale parallel learning is performed on GPU clusters. As a technical effect, this data collection unit can analyze vast real-time data quickly and with high accuracy compared to manual analysis of SNS activity and selection of collection targets by humans, and efficiently collect only highly relevant data optimized for each user, thereby achieving remarkable effects such as reduction of information noise, improved personalization accuracy, and overall system efficiency. Application fields include personalized news distribution, ad targeting, learning status tracking in education, and real-time behavioral monitoring in healthcare, among many other use cases.

The preference analysis unit can estimate the user's emotions and adjust the method of preference analysis based on the estimated emotions. For example, the preference analysis unit estimates the user's emotions. The user's emotions may include stress, relaxation, excitement, etc., but are not limited thereto. The preference analysis unit can estimate emotions using technologies such as facial expression recognition and text analysis. The preference analysis unit also adjusts the method of preference analysis based on the estimated emotions. For example, if the user is feeling stressed, content that helps relaxation can be preferentially analyzed. If the user is relaxed, interesting news and articles can be preferentially analyzed. Furthermore, if the user is excited, highly entertaining content can be preferentially analyzed. Thus, by adjusting the method of preference analysis according to the user's emotions, more appropriate analysis becomes possible. Emotion estimation may be realized using emotion engines or generative AI, for example, by using emotion estimation functions. Generative AI may include text generation AI (e.g., LLM) or multimodal generative AI, but is not limited thereto. Some or all of the above-described processing in the preference analysis unit may be performed using AI, or may be performed without using AI. For example, the preference analysis unit can input the user's facial expression data to generative AI and have the generative AI perform emotion estimation. Specifically, this preference analysis unit simultaneously obtains the user's facial image data (e.g., face image tensor 224×224×3, 30 frames per second), audio data (e.g., 5 seconds of audio waveform, 16kHz sampling), and text data (e.g., SNS posts or chat history, up to 512 tokens), and normalizes and extracts features using a multimodal preprocessing module. Facial images are encoded using a convolutional neural network (e.g., ResNet-50), audio is converted to a spectrogram and emotion features are extracted using a recurrent neural network or Transformer, and text is converted to emotion embedding vectors using a pretrained language model (e.g., BERT). These features are integrated and input to a multimodal emotion estimation model (e.g., Late Fusion-type Transformer) to obtain outputs such as “emotion label (e.g., stress, relaxation, excitement)” and “emotion intensity score (e.g., stress 0.7, relaxation 0.2, excitement 0.1).” Example inputs include “sequence of face image frames+audio waveform+text such as ‘I was busy and tired today’,” and example outputs include “emotion label: stress, intensity 0.8” or “emotion label: relaxation, intensity 0.6.” This preference analysis unit uses these emotion estimation results to dynamically adjust the parameters of the preference analysis algorithm (e.g., weights for target categories, priority of target articles, analysis window width, etc.). For example, in a stress state, the weight for relaxation content is increased, and in an excited state, the priority for entertainment analysis is raised. For AI model training, multimodal datasets with emotion annotations are used, cross-entropy loss functions and multitask learning are applied, and large-scale parallel learning is performed on GPU clusters. As a subsequent process, the history of estimated emotions and analysis methods is recorded and used for future model optimization and personalization for each user. As a technical effect, this preference analysis unit can analyze vast multimodal data quickly and with high accuracy compared to subjective judgment by humans to adjust analysis methods, and realize preference analysis optimized for the user's psychological state, thereby achieving remarkable effects such as improved personalization accuracy, enhanced user experience, and overall system efficiency. Application fields include personalized news distribution, stress monitoring in healthcare, learning status tracking in education, and emotion response analysis in marketing, among many other use cases.

The preference analysis unit can appropriately adjust the analysis algorithm by referring to the user's past preference data during preference analysis. For example, the preference analysis unit refers to the user's past preference data during preference analysis. Past preference data may include preference data within a specific period, but is not limited thereto. The preference analysis unit appropriately adjusts the analysis algorithm by referring to the user's past preference data. For example, the preference analysis unit can optimize the analysis algorithm based on news categories that the user has preferred to browse in the past. The preference analysis unit can also refer to the user's past preference data to preferentially analyze content that the user is likely to be interested in. Furthermore, the preference analysis unit can preferentially analyze highly relevant content based on the user's past preference data. Thus, by referring to past preference data, the analysis algorithm can be optimized. Some or all of the above-described processing in the preference analysis unit may be performed using AI, or may be performed without using AI. For example, the preference analysis unit can input the user's past preference data to AI and have the AI adjust the analysis algorithm. Specifically, this preference analysis unit records and manages “past 30 days of preference data” for each user as a time-series tensor (e.g., 1000 items×10 dimensions, each element including preference date/time, preference category, preference intensity score, browsing device, preference reason tag, user response (e.g., click presence), preference source ID, etc.). The preference analysis unit inputs these history data to a time-series analysis module and uses autoregressive models or LSTM-type recurrent neural networks to extract preference patterns for each user (e.g., frequent technology preferences at night on weekdays, increased entertainment preferences on weekends, etc.). Furthermore, clustering algorithms (e.g., K-means) and association rule mining are applied to automatically extract features such as “high-frequency preference categories,” “time periods with high preference intensity,” and “content with good user response” from the preference history. When using AI, a Transformer-based history pattern analysis model is used, with “preference history tensor” as input and outputs such as “recommended analysis method (e.g., increase weight for category A, expand analysis window at night),” and “analysis priority list (e.g., technology, entertainment, sports).” Example inputs include “preference history tensor from May 1 to May 30, 2024,” “device usage history vector,” and “user response series,” and example outputs include “recommended method: focus on technology, strengthen analysis at night,” “priority categories: entertainment, sports.” These outputs are reflected in the actual preference analysis algorithm parameter adjustment and analysis target selection module, realizing an optimized preference analysis flow for each user. For AI model training, past preference history, analysis accuracy, and user response data are used as training data, cross-entropy loss functions and time-series regularization are applied, and large-scale parallel learning is performed on GPU clusters. As a technical effect, this preference analysis unit can analyze vast history data quickly and with high accuracy compared to selection of analysis methods based on human experience, and can automatically determine the optimal analysis method, timing, and targets for each user, thereby achieving remarkable effects such as improved analysis efficiency, personalization accuracy, and overall system response speed. Application fields include personalized news distribution, behavioral monitoring in healthcare, learning history analysis in education, and data analysis optimization for IoT devices, among many other use cases.

The preference analysis unit can track changes in the user's interests in real time during preference analysis and update the analysis results. For example, the preference analysis unit tracks changes in the user's interests in real time during preference analysis. Changes in interests may include real-time search keywords and social media trends, but are not limited thereto. The preference analysis unit tracks changes in the user's interests in real time and updates the analysis results. For example, when the user's interests change, the preference analysis unit can update the analysis results in real time. The preference analysis unit can also track changes in the user's interests and update the analysis results based on the latest interests. Furthermore, the preference analysis unit can track changes in the user's interests in real time and immediately reflect them in the analysis results. Thus, by tracking changes in interests in real time, the latest analysis results can be provided. Some or all of the above-described processing in the preference analysis unit may be performed using AI, or may be performed without using AI. For example, the preference analysis unit can input changes in the user's interests to AI and have the AI update the analysis results. Specifically, this preference analysis unit structures the user's real-time behavioral data (e.g., current search keyword vector (20 dimensions), browsing page title, activity log, SNS post content, trend word frequency series, etc.) as time-series tensors or category vectors, and performs tokenization, category classification, and trend detection using a natural language processing module. The preference analysis unit inputs these data to a time-series autoregressive model, recurrent neural network (e.g., LSTM), or Transformer-based time-series change detection model to detect change points and trend shifts in the user's interest categories with high accuracy. Example inputs include “search keyword vector for the past hour,” “latest SNS post text,” and “real-time browsing page title,” and example outputs include “interest category change: technology→entertainment,” “trend words: AI technology, film festival.” The preference analysis unit uses these outputs to immediately update analysis results (e.g., interest category distribution, recommended content list, analysis window width) and realize analysis optimized for the user's latest interests. For AI model training, past real-time behavioral data and interest change history are used as training data, cross-entropy loss functions and time-series regularization are applied, and large-scale parallel learning is performed on GPU clusters. As a technical effect, this preference analysis unit can analyze vast real-time data quickly and with high accuracy compared to manual determination of interest changes and updating of analysis results by humans, and can immediately provide the latest analysis results optimized for each user, thereby achieving remarkable effects such as improved real-time information provision, personalization accuracy, user satisfaction, and overall system response speed. Application fields include personalized news distribution, ad targeting, learning status tracking in education, and real-time behavioral monitoring in healthcare, among many other use cases.

The preference analysis unit can estimate the user's emotions and determine the priority of preference analysis based on the estimated emotions. For example, the preference analysis unit estimates the user's emotions. The user's emotions may include stress, relaxation, excitement, etc., but are not limited thereto. The preference analysis unit can estimate emotions using technologies such as facial expression recognition and text analysis. The preference analysis unit also determines the priority of preference analysis based on the estimated emotions. For example, if the user is feeling stressed, content that helps relaxation can be preferentially analyzed. If the user is relaxed, interesting news and articles can be preferentially analyzed. Furthermore, if the user is excited, highly entertaining content can be preferentially analyzed. Thus, by determining the priority of analysis according to the user's emotions, more appropriate analysis becomes possible. Emotion estimation may be realized using emotion engines or generative AI, for example, by using emotion estimation functions. Generative AI may include text generation AI (e.g., LLM) or multimodal generative AI, but is not limited thereto. Some or all of the above-described processing in the preference analysis unit may be performed using AI, or may be performed without using AI. For example, the preference analysis unit can input the user's facial expression data to generative AI and have the generative AI perform emotion estimation. Specifically, this preference analysis unit simultaneously obtains the user's facial image data (e.g., face image tensor 224×224×3, 30 frames per second), audio data (e.g., 5 seconds of audio waveform, 16 kHz sampling), and text data (e.g., SNS posts or chat history, up to 512 tokens), and normalizes and extracts features using a multimodal preprocessing module. Facial images are encoded using a convolutional neural network (e.g., ResNet-50), audio is converted to a spectrogram and emotion features are extracted using a recurrent neural network or Transformer, and text is converted to emotion embedding vectors using a pretrained language model (e.g., BERT). These features are integrated and input to a multimodal emotion estimation model (e.g., Late Fusion-type Transformer) to obtain outputs such as “emotion label (e.g., stress, relaxation, excitement)” and “emotion intensity score (e.g., stress 0.7, relaxation 0.2, excitement 0.1).” Example inputs include “sequence of face image frames+audio waveform+text such as ‘I was busy and tired today’,” and example outputs include “emotion label: stress, intensity 0.8” or “emotion label: relaxation, intensity 0.6.” This preference analysis unit uses these emotion estimation results in the preference analysis priority determination module to dynamically assign priorities such as “relaxation content prioritized during stress, intellectually curious news prioritized during relaxation, entertainment content prioritized during excitement,” and reflects them in the actual analysis scheduler and analysis target selection module. For AI model training, multimodal datasets with emotion annotations are used, cross-entropy loss functions and multitask learning are applied, and large-scale parallel learning is performed on GPU clusters. As a subsequent process, the history of estimated emotions and analysis priorities is recorded and used for future model optimization and personalization for each user. As a technical effect, this preference analysis unit can analyze vast multimodal data quickly and with high accuracy compared to subjective judgment by humans to determine analysis priorities, and realize preference analysis optimized for the user's psychological state, thereby achieving remarkable effects such as improved personalization accuracy, enhanced user experience, and overall system efficiency. Application fields include personalized news distribution, stress monitoring in healthcare, learning status tracking in education, and emotion response analysis in marketing, among many other use cases.

The preference analysis unit can perform analysis during preference analysis by considering the user's geographic location information. For example, the preference analysis unit considers the user's geographic location information during preference analysis. Geographic location information may include GPS data or IP addresses, but is not limited thereto. The preference analysis unit performs analysis based on the user's geographic location information. For example, the preference analysis unit can preferentially analyze news or information related to the region where the user is currently located. The preference analysis unit can also analyze local event or weather information based on the user's geographic location. Furthermore, the preference analysis unit can preferentially analyze region-specific topics by considering the user's location information. Thus, by considering geographic location information, region-specific highly relevant analysis becomes possible. Some or all of the above-described processing in the preference analysis unit may be performed using AI, or may be performed without using AI. For example, the preference analysis unit can input the user's geographic location information to AI and have the AI perform highly relevant analysis. Specifically, this preference analysis unit obtains the user's GPS coordinates (e.g., latitude and longitude as a 2-dimensional vector), region code estimated from IP address, and Wi-Fi access point information in real time, and standardizes them using a geographic information normalization module. The preference analysis unit matches geographic location information with a map database or regional category dictionary and converts it to category labels such as “prefecture,” “city/ward/town/village,” or “landmark.” The preference analysis unit uses these geographic features as input to dynamically select region-specific preference analysis algorithms (e.g., weighting for local news categories, priority adjustment for regional events, analysis linked to weather information) and calculates a regional relevance score (e.g., 0.0 to 1.0). When using AI, the preference analysis unit uses a multilayer perceptron or Transformer-based geographic information relevance estimation model, with “GPS vector,” “region category,” and “user's past region-specific interest distribution” as input, and outputs such as “priority analysis categories (e.g., local news, regional events, weather information)” and “analysis priority score.” Example inputs include “GPS: 35.6895,139.6917 (central Tokyo),” “IP: xxx.xxx.xxx.xxx (Osaka City),” and example outputs include “priority categories: Tokyo events, weather information, regional news.” The preference analysis unit uses these outputs to perform filtering and prioritization of analysis target data, efficiently analyzing region-specific information. For AI model training, past region-specific user behavior data and click history are used as training data, cross-entropy loss functions and geographic balance adjustment are applied, and large-scale parallel learning is performed on GPU clusters. As a subsequent process, the analysis results are passed to the newsletter generation unit and news collection unit and used for personalized generation of region-specific newsletters and local event information. As a technical effect, this preference analysis unit can analyze vast geographic data quickly and with high accuracy compared to manual determination of regional information and selection of analysis targets by humans, and efficiently realize region-specific analysis optimized for each user, thereby achieving remarkable effects such as reduction of information noise, improved personalization accuracy, overall system efficiency, and realization of region-focused services. Application fields include personalized news distribution, region-focused advertising, tourism information provision, disaster information distribution, local event guidance, and region-specific educational content distribution, among many other use cases.

The preference analysis unit can improve the accuracy of analysis by referring to the user's social media activity during preference analysis. For example, the preference analysis unit refers to the user's social media activity during preference analysis. Social media activity includes post content, likes, shares, and the like, but is not limited thereto. The preference analysis unit improves the accuracy of analysis by referring to the user's social media activity. For example, the preference analysis unit can analyze data related to articles shared by the user on social media. In addition, the preference analysis unit can analyze the post content of accounts followed by the user and analyze related data. Furthermore, the preference analysis unit can analyze data that the user is likely to be interested in based on the user's activity history on social media. By referring to social media activity, the accuracy of analysis is improved. Some or all of the above-described processing in the preference analysis unit may be performed using AI or without using AI. For example, the preference analysis unit can input the user's social media activity to AI and have the AI perform accuracy improvement of the analysis. Specifically, the preference analysis unit obtains the user's SNS post text (e.g., up to 20 posts per day, each post up to 500 tokens), like/share numerical time series (e.g., number of actions per day), and follow account list (e.g., up to 1,000 accounts) via API, and performs tokenization, category classification, and sentiment analysis using a natural language processing module. The preference analysis unit embeds post content as vectors using BERT or Word2Vec, and normalizes action time series. Using these features as input, a social graph analysis module or clustering algorithm (e.g., K-means) is applied to extract user interest clusters and trending topics. When using AI, the preference analysis unit inputs “post text vectors,” “action time series,” and “follow account features” into a Transformer-based multimodal classification model, and generates outputs such as “priority analysis categories (e.g., technology, entertainment, sports),” “relevance scores,” and “recommended analysis target lists (e.g., news related to shared articles, new articles from followed authors).” For example, input “Post: AI technology is interesting, Shares: 10, Follows: technology accounts,” output “Priority category: Technology, Recommended analysis: AI-related news.” Based on these outputs, the preference analysis unit performs filtering and prioritization of analysis target data to achieve analysis optimized for the user's interests. For AI model training, past SNS behavior and corresponding data of click history and interest categories are used as training data, cross-entropy loss functions and category balance adjustment are applied, and large-scale parallel training is performed on GPU-based parallel computing clusters. As subsequent processing, the analysis results are passed to the newsletter generation unit and the news collection unit, and are used to improve the accuracy of SNS trend-reflecting newsletters and personalized recommendations. As a technical effect, the preference analysis unit can efficiently perform only highly relevant analysis optimized for each user by analyzing vast amounts of real-time data quickly and accurately, compared to manual analysis and selection of SNS activity by humans, thereby achieving remarkable effects such as reduction of information noise, improvement of personalization accuracy, overall system efficiency, and realization of trend-reflecting services. Application fields include personalized news distribution, ad targeting, learning status monitoring in education, real-time behavior monitoring in healthcare, SNS trend analysis, and various other use cases.

The news collection unit can estimate the user's emotions and adjust the method of news collection based on the estimated emotions. For example, the news collection unit estimates the user's emotions. The user's emotions include stress, relaxation, excitement, and the like, but are not limited thereto. The news collection unit can estimate emotions using technologies such as facial expression recognition and text analysis. In addition, the news collection unit adjusts the method of news collection based on the estimated user's emotions. For example, if the user is feeling stressed, the news collection unit can preferentially collect relaxing news. If the user is relaxed, the news collection unit can preferentially collect interesting news. Furthermore, if the user is excited, the news collection unit can preferentially collect highly entertaining news. By adjusting the method of news collection according to the user's emotions, more appropriate news can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the news collection unit may be performed using AI or without using AI. For example, the news collection unit can input the user's facial expression data to generative AI and have the generative AI perform emotion estimation.

The news collection unit can appropriately adjust the collection algorithm by referring to the user's past news browsing history during news collection. For example, the news collection unit refers to the user's past news browsing history during news collection. The past news browsing history includes news browsing data within a specific period, but is not limited thereto. The news collection unit appropriately adjusts the collection algorithm by referring to the user's past news browsing history. For example, the news collection unit can optimize the collection algorithm based on the categories of news browsed by the user in the past. In addition, the news collection unit can preferentially collect news that the user is likely to be interested in by referring to the user's past news browsing history. Furthermore, the news collection unit can preferentially collect highly relevant news based on the user's past news browsing history. By referring to the past news browsing history, the collection algorithm can be optimized. Some or all of the above-described processing in the news collection unit may be performed using AI or without using AI. For example, the news collection unit can input the user's past news browsing history to AI and have the AI perform adjustment of the collection algorithm.

The news collection unit can track changes in the user's interests in real time during news collection and update the collection results. For example, the news collection unit tracks changes in the user's interests in real time during news collection. Changes in interests include real-time search keywords, social media trends, and the like, but are not limited thereto. The news collection unit tracks changes in the user's interests in real time and updates the collection results. For example, if the user's interests change, the news collection unit can update the collection results in real time. In addition, the news collection unit can track changes in the user's interests and update the collection results based on the latest interests. Furthermore, the news collection unit can track changes in the user's interests in real time and immediately reflect them in the collection results. By tracking changes in interests in real time, the latest collection results can be provided. Some or all of the above-described processing in the news collection unit may be performed using AI or without using AI. For example, the news collection unit can input changes in the user's interests to AI and have the AI perform updating of the collection results.

The news collection unit can estimate the user's emotions and determine the priority of news to be collected based on the estimated emotions. For example, the news collection unit estimates the user's emotions. The user's emotions include stress, relaxation, excitement, and the like, but are not limited thereto. The news collection unit can estimate emotions using technologies such as facial expression recognition and text analysis. In addition, the news collection unit determines the priority of news to be collected based on the estimated user's emotions. For example, if the user is feeling stressed, the news collection unit can preferentially collect relaxing news. If the user is relaxed, the news collection unit can preferentially collect interesting news. Furthermore, if the user is excited, the news collection unit can preferentially collect highly entertaining news. By determining the priority of news according to the user's emotions, more appropriate news can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the news collection unit may be performed using AI or without using AI. For example, the news collection unit can input the user's facial expression data to generative AI and have the generative AI perform emotion estimation.

The news collection unit can preferentially collect highly relevant news by considering the user's geographic location information during news collection. For example, the news collection unit considers the user's geographic location information during news collection. Geographic location information includes GPS data, IP addresses, and the like, but is not limited thereto. The news collection unit preferentially collects highly relevant news based on the user's geographic location information. For example, the news collection unit can preferentially collect news related to the region where the user is currently located. In addition, the news collection unit can collect local event or weather information based on the user's geographic location. Furthermore, the news collection unit can preferentially collect region-specific news by considering the user's location information. By considering geographic location information, highly relevant region-specific news can be collected. Some or all of the above-described processing in the news collection unit may be performed using AI or without using AI. For example, the news collection unit can input the user's geographic location information to AI and have the AI perform collection of highly relevant news.

The news collection unit can improve the accuracy of collection by referring to the user's social media activity during news collection. For example, the news collection unit refers to the user's social media activity during news collection. Social media activity includes post content, likes, shares, and the like, but is not limited thereto. The news collection unit improves the accuracy of collection by referring to the user's social media activity. For example, the news collection unit can collect news related to articles shared by the user on social media. In addition, the news collection unit can analyze the post content of accounts followed by the user and collect related news. Furthermore, the news collection unit can collect news that the user is likely to be interested in based on the user's activity history on social media. By referring to social media activity, the accuracy of collection is improved. Some or all of the above-described processing in the news collection unit may be performed using AI or without using AI. For example, the news collection unit can input the user's social media activity to AI and have the AI perform accuracy improvement of collection.

The newsletter generation unit can estimate the user's emotions and adjust the method of expression of the newsletter based on the estimated emotions. For example, the newsletter generation unit estimates the user's emotions. The user's emotions include stress, relaxation, excitement, and the like, but are not limited thereto. The newsletter generation unit can estimate emotions using technologies such as facial expression recognition and text analysis. In addition, the newsletter generation unit adjusts the method of expression of the newsletter based on the estimated user's emotions. For example, if the user is feeling stressed, the newsletter generation unit can create a newsletter using relaxing expressions. If the user is relaxed, the newsletter generation unit can create a newsletter using interesting expressions. Furthermore, if the user is excited, the newsletter generation unit can create a newsletter using highly entertaining expressions. By adjusting the method of expression of the newsletter according to the user's emotions, more appropriate newsletters can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the newsletter generation unit may be performed using AI or without using AI. For example, the newsletter generation unit can input the user's facial expression data to generative AI and have the generative AI perform emotion estimation.

The newsletter generation unit can appropriately adjust the level of detail of the newsletter based on the user's interests during newsletter generation. For example, the newsletter generation unit adjusts the level of detail of the newsletter based on the user's interests during newsletter generation. The level of detail of the newsletter includes the depth of information, length of articles, and the like, but is not limited thereto. If the user has a strong interest in a particular topic, the newsletter generation unit can create a newsletter containing detailed information about that topic. In addition, if the user is interested in a wide range of topics, the newsletter generation unit can create a newsletter covering multiple topics. Furthermore, the newsletter generation unit can adjust the level of detail of the newsletter based on the user's interests to provide an optimal amount of information. By adjusting the level of detail of the newsletter based on interests, an optimal amount of information can be provided. Some or all of the above-described processing in the newsletter generation unit may be performed using AI or without using AI. For example, the newsletter generation unit can input the user's interests to AI and have the AI perform adjustment of the level of detail of the newsletter.

The newsletter generation unit can apply different generation algorithms according to the category of the user's interests during newsletter generation. For example, the newsletter generation unit applies different generation algorithms according to the category of the user's interests during newsletter generation. Categories of interests include news categories, entertainment categories, and the like, but are not limited thereto. If the user is interested in technology, the newsletter generation unit can apply an algorithm that preferentially features technology-related news. In addition, if the user is interested in entertainment, the newsletter generation unit can apply an algorithm that preferentially features entertainment-related news. Furthermore, the newsletter generation unit can apply the optimal generation algorithm according to the category of the user's interests to create a customized newsletter. By applying generation algorithms according to the category of interests, more appropriate newsletters can be provided. Some or all of the above-described processing in the newsletter generation unit may be performed using AI or without using AI. For example, the newsletter generation unit can input the category of the user's interests to AI and have the AI perform application of the generation algorithm.

The newsletter generation unit can estimate the user's emotions and adjust the length of the newsletter based on the estimated emotions. For example, the newsletter generation unit estimates the user's emotions. The user's emotions include stress, relaxation, excitement, and the like, but are not limited thereto. The newsletter generation unit can estimate emotions using technologies such as facial expression recognition and text analysis. In addition, the newsletter generation unit adjusts the length of the newsletter based on the estimated user's emotions. For example, if the user is feeling stressed, the newsletter generation unit can create a short and concise newsletter. If the user is relaxed, the newsletter generation unit can create a longer newsletter containing detailed information. Furthermore, if the user is excited, the newsletter generation unit can create a newsletter containing highly entertaining content. By adjusting the length of the newsletter according to the user's emotions, more appropriate newsletters can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the newsletter generation unit may be performed using AI or without using AI. For example, the newsletter generation unit can input the user's facial expression data to generative AI and have the generative AI perform emotion estimation.

The newsletter generation unit can determine the priority of the newsletter based on the timing of submission of the user's interests during newsletter generation. For example, the newsletter generation unit considers the timing of submission of the user's interests during newsletter generation. The timing of submission of interests includes before or after specific events, specific periods, and the like, but is not limited thereto. The newsletter generation unit determines the priority of the newsletter based on the timing of submission of the user's interests. For example, the newsletter generation unit can preferentially feature news about topics that the user has recently become interested in. In addition, the newsletter generation unit can preferentially feature news about topics that the user has been interested in for a long time. Furthermore, the newsletter generation unit can determine the optimal priority of the newsletter based on the timing of submission of the user's interests. By determining the priority of the newsletter based on the timing of submission of interests, more appropriate newsletters can be provided. Some or all of the above-described processing in the newsletter generation unit may be performed using AI or without using AI. For example, the newsletter generation unit can input the timing of submission of the user's interests to AI and have the AI perform determination of the priority of the newsletter.

The newsletter generation unit can adjust the order of the newsletter based on the relevance of the user's interests during newsletter generation. For example, the newsletter generation unit considers the relevance of the user's interests during newsletter generation. The relevance of interests includes topic relevance, degree of user interest, and the like, but is not limited thereto. The newsletter generation unit adjusts the order of the newsletter based on the relevance of the user's interests. For example, the newsletter generation unit can place news about topics in which the user has a strong interest at the beginning. In addition, if the user has broad interests, the newsletter generation unit can preferentially place highly relevant news. Furthermore, the newsletter generation unit can optimize the order of the newsletter based on the relevance of the user's interests. By adjusting the order of the newsletter based on the relevance of interests, more appropriate newsletters can be provided. Some or all of the above-described processing in the newsletter generation unit may be performed using AI or without using AI. For example, the newsletter generation unit can input the relevance of the user's interests to AI and have the AI perform adjustment of the order of the newsletter.

The newsletter provision unit can estimate the user's emotions and adjust the method of providing the newsletter based on the estimated emotions. For example, the newsletter provision unit estimates the user's emotions. The user's emotions include stress, relaxation, excitement, and the like, but are not limited thereto. The newsletter provision unit can estimate emotions using technologies such as facial expression recognition and text analysis. In addition, the newsletter provision unit adjusts the method of providing the newsletter based on the estimated user's emotions. For example, if the user is feeling stressed, the newsletter provision unit can provide the newsletter in a relaxing manner. If the user is relaxed, the newsletter provision unit can provide the newsletter in an interesting manner. Furthermore, if the user is excited, the newsletter provision unit can provide the newsletter in a highly entertaining manner. By adjusting the method of providing the newsletter according to the user's emotions, more appropriate newsletters can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the newsletter provision unit may be performed using AI or without using AI. For example, the newsletter provision unit can input the user's facial expression data to generative AI and have the generative AI perform emotion estimation.

The newsletter provision unit can select an optimal provision method by referring to the user's past newsletter browsing history during newsletter provision. For example, the newsletter provision unit refers to the user's past newsletter browsing history during newsletter provision. The past newsletter browsing history includes newsletter browsing data within a specific period, but is not limited thereto. The newsletter provision unit selects an optimal provision method by referring to the user's past newsletter browsing history. For example, the newsletter provision unit can preferentially select the provision method of newsletters that the user has preferred to browse in the past. In addition, the newsletter provision unit can select an optimal provision method by referring to the user's past newsletter browsing history. Furthermore, the newsletter provision unit can select a highly relevant provision method based on the user's past newsletter browsing history. By referring to the past newsletter browsing history, an optimal provision method can be selected. Some or all of the above-described processing in the newsletter provision unit may be performed using AI or without using AI. For example, the newsletter provision unit can input the user's past newsletter browsing history to AI and have the AI perform selection of the optimal provision method.

The newsletter provision unit can track changes in the user's interests in real time during newsletter provision and update the provision results. For example, the newsletter provision unit tracks changes in the user's interests in real time during newsletter provision. Changes in interests include real-time search keywords, social media trends, and the like, but are not limited thereto. The newsletter provision unit tracks changes in the user's interests in real time and updates the provision results. For example, if the user's interests change, the newsletter provision unit can update the provision results in real time. In addition, the newsletter provision unit can track changes in the user's interests and update the provision results based on the latest interests. Furthermore, the newsletter provision unit can track changes in the user's interests in real time and immediately reflect them in the provision results. By tracking changes in interests in real time, the latest provision results can be provided. Some or all of the above-described processing in the newsletter provision unit may be performed using AI or without using AI. For example, the newsletter provision unit can input changes in the user's interests to AI and have the AI perform updating of the provision results.

The newsletter provision unit can estimate the user's emotions and adjust the frequency of providing the newsletter based on the estimated emotions. For example, the newsletter provision unit estimates the user's emotions. The user's emotions include stress, relaxation, excitement, and the like, but are not limited thereto. The newsletter provision unit can estimate emotions using technologies such as facial expression recognition and text analysis. In addition, the newsletter provision unit adjusts the frequency of providing the newsletter based on the estimated user's emotions. For example, if the user is feeling stressed, the newsletter provision unit can reduce the frequency of provision to alleviate the burden. If the user is relaxed, the newsletter provision unit can increase the frequency of provision to enrich the information. Furthermore, if the user is excited, the newsletter provision unit can provide the newsletter in real time. By adjusting the frequency of providing the newsletter according to the user's emotions, more appropriate newsletters can be provided. Emotion estimation is realized, for example, by using emotion engines or generative AI with emotion estimation functions. Generative AI includes text generation AI (e.g., LLM) and multimodal generative AI, but is not limited thereto. Some or all of the above-described processing in the newsletter provision unit may be performed using AI or without using AI. For example, the newsletter provision unit can input the user's facial expression data to generative AI and have the generative AI perform emotion estimation.

The newsletter provision unit can select an appropriate provision method by considering the user's geographic location information during newsletter provision. For example, the newsletter provision unit considers the user's geographic location information during newsletter provision. Geographic location information includes GPS data, IP addresses, and the like, but is not limited thereto. The newsletter provision unit selects an appropriate provision method based on the user's geographic location information. For example, the newsletter provision unit can preferentially provide news related to the region where the user is currently located. In addition, the newsletter provision unit can provide local event or weather information based on the user's geographic location. Furthermore, the newsletter provision unit can preferentially provide region-specific news by considering the user's location information. By considering geographic location information, highly relevant region-specific news can be provided. Some or all of the above-described processing in the newsletter provision unit may be performed using AI or without using AI. For example, the newsletter provision unit can input the user's geographic location information to AI and have the AI perform selection of the appropriate provision method.

The newsletter provision unit can improve the accuracy of provision by referring to the user's social media activity during newsletter provision. For example, the newsletter provision unit refers to the user's social media activity during newsletter provision. Social media activity includes post content, likes, shares, and the like, but is not limited thereto. The newsletter provision unit improves the accuracy of provision by referring to the user's social media activity. For example, the newsletter provision unit can provide news related to articles shared by the user on social media. In addition, the newsletter provision unit can analyze the post content of accounts followed by the user and provide related news. Furthermore, the newsletter provision unit can provide news that the user is likely to be interested in based on the user's activity history on social media. By referring to social media activity, the accuracy of provision is improved. Some or all of the above-described processing in the newsletter provision unit may be performed using AI or without using AI. For example, the newsletter provision unit can input the user's social media activity to AI and have the AI perform accuracy improvement of provision.

The system according to the embodiment is not limited to the above-described examples, and various modifications are possible, for example, as follows.

The newsletter provision unit can refer to the user's past newsletter browsing history to analyze trends in articles that the user was most interested in and reflect these trends in the next newsletter. For example, it can identify categories of articles that the user frequently clicked on in the past and preferentially provide the latest news related to those categories. In addition, if the user prefers articles by a specific author, new articles by that author can be preferentially collected and included in the newsletter. Furthermore, if the user tends to open newsletters at specific times of day, the newsletter can be delivered to match those times. In this way, more personalized newsletters can be provided by utilizing the user's past behavioral data.

The newsletter generation unit can dynamically change the layout of the newsletter based on the user's interests. For example, if the user prefers visual content, a layout containing many images or videos can be adopted. If the user prefers text-based information, a text-centric layout can be provided. Furthermore, if the user prefers a specific format (for example, list format or grid format), the newsletter can be generated in that format. As a result, the newsletter can be provided in the optimal layout according to the user's preferences.

The news collection unit can evaluate the reliability of news based on the user's interests and preferentially collect highly reliable news. For example, it can refer to the reliability score of news sites and preferentially collect news from sites with high scores. In addition, it can evaluate the reliability of the news source or author and preferentially collect news from highly reliable sources or authors. Furthermore, it can analyze the content of news and preferentially collect news with a low possibility of being fake news. In this way, highly reliable news can be provided to the user.

The newsletter provision unit can optimize the display format of the newsletter according to the user's device. For example, for users viewing on a smartphone, a vertically oriented layout can be adopted, and for users viewing on a tablet or desktop, a horizontally oriented layout can be provided. In addition, font size and image size can be adjusted according to the device's screen size to improve readability. Furthermore, interactive elements can be added according to the characteristics of the device (for example, touchscreen or mouse operation). As a result, newsletters optimized for the user's device can be provided.

The newsletter generation unit can dynamically adjust the delivery frequency of the newsletter based on the user's interests. For example, if the user shows strong interest in a specific topic, news related to that topic can be delivered frequently. If the user is interested in a wide range of topics, newsletters covering multiple topics can be delivered regularly. Furthermore, if the user's interests change, the delivery frequency can be adjusted according to the change. In this way, the newsletter can be provided at the optimal delivery frequency according to the user's interests.

The newsletter generation unit can estimate the user's emotions and adjust the content of the newsletter based on the estimated emotions. For example, if the user is feeling stressed, relaxing content or positive news can be preferentially provided. If the user is relaxed, interesting news or in-depth articles can be provided. Furthermore, if the user is excited, highly entertaining content or trending news can also be provided. In this way, the optimal newsletter can be provided according to the user's emotions.

The newsletter provision unit can estimate the user's emotions and adjust the delivery timing of the newsletter based on the estimated emotions. For example, if the user is feeling stressed, the newsletter can be delivered during a relaxing time. If the user is relaxed, it can be delivered during a time when the user can concentrate on reading. Furthermore, if the user is excited, the newsletter can be delivered in real time. In this way, the newsletter can be provided at the optimal delivery timing according to the user's emotions.

The news collection unit can estimate the user's emotions and adjust the scope of news collection based on the estimated emotions. For example, if the user is feeling stressed, relaxing news or positive news can be preferentially collected. If the user is relaxed, interesting news or in-depth articles can be collected. Furthermore, if the user is excited, highly entertaining news or trending news can also be collected. In this way, the optimal news can be collected according to the user's emotions.

The newsletter generation unit can estimate the user's emotions and adjust the design of the newsletter based on the estimated emotions. For example, if the user is feeling stressed, a calm color scheme or simple design can be adopted. If the user is relaxed, a bright color scheme or interactive design can be adopted. Furthermore, if the user is excited, a highly entertaining design or animations can also be incorporated. In this way, the newsletter can be provided in the optimal design according to the user's emotions.

The newsletter provision unit can estimate the user's emotions and adjust the notification method of the newsletter based on the estimated emotions. For example, if the user is feeling stressed, notifications can be sent with a quiet notification sound or vibration. If the user is relaxed, notifications can be sent with a normal notification sound. Furthermore, if the user is excited, notifications can be sent with a prominent notification sound or pop-up notification. In this way, the newsletter can be provided using the optimal notification method according to the user's emotions.

Below, the processing flow of Example of the Embodiment will be briefly described.
Step 1: The data collection unit collects user data. User data includes browsing history, search history, and activity data on social media. For example, the data collection unit collects the user's past browsing history and acquires browsing data within a specific period. It can also collect the user's search history and acquire data based on specific search engines or keywords. Furthermore, it can collect activity data on social media and acquire data such as the user's posts, likes, and shares.
Step 2: The preference analysis unit analyzes the data collected by the data collection unit and identifies the user's preferences and interests. For example, the preference analysis unit analyzes the user's browsing history to identify interests in specific news categories or topics. It can also analyze the user's search history and identify interests based on specific keywords or search patterns. Furthermore, it can analyze activity data on social media and identify interests based on trends in articles shared by the user or the content of accounts followed by the user.
Step 3: The news collection unit collects news or articles based on the user's interests obtained by the preference analysis unit. For example, the news collection unit collects the latest information from news sites, blogs, or social media on the Internet. It can collect the latest news from specific news sites or blogs and filter them based on the user's interests. It can also collect the latest posts from social media and filter them based on the user's interests.
Step 4: The newsletter generation unit creates a customized newsletter based on the news or articles collected by the news collection unit. For example, the newsletter generation unit selects articles that match the user's interests and summarizes them using expressions that attract the user's attention. It can change the article titles or lead sentences to catchy expressions to attract the user's interest. In addition, it can concisely summarize the article content so that the user can quickly grasp the content.
Step 5: The newsletter provision unit provides the newsletter generated by the newsletter generation unit to the user. For example, the newsletter provision unit provides the generated newsletter to the user by email delivery or app notification. The newsletter can include links to the original articles, and the user can be guided to a specific platform by clicking on articles of interest.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described data collection unit, preference analysis unit, news collection unit, newsletter generation unit, and newsletter provision unit may be implemented by at least one of, for example, a smart device 14 and a data processing apparatus 12. For example, the data collection unit may be implemented by a control unit 46A of the smart device 14 and collect the user's browsing history, search history, and activity data on social media. The preference analysis unit may be implemented by, for example, a specific processing unit 290 of the data processing apparatus 12 and analyze the collected data to identify user preferences and interests. The news collection unit may be implemented by, for example, the specific processing unit 290 of the data processing apparatus 12 and collect the latest information from news sites, blogs, or social media on the Internet. The newsletter generation unit may be implemented by, for example, the specific processing unit 290 of the data processing apparatus 12 and create a customized newsletter based on the collected news or articles. The newsletter provision unit may be implemented by, for example, the control unit 46A of the smart device 14 and provide the generated newsletter to the user. The correspondence between each unit and the apparatus or control unit is not limited to the above examples and various modifications are possible.

### Second Embodiment

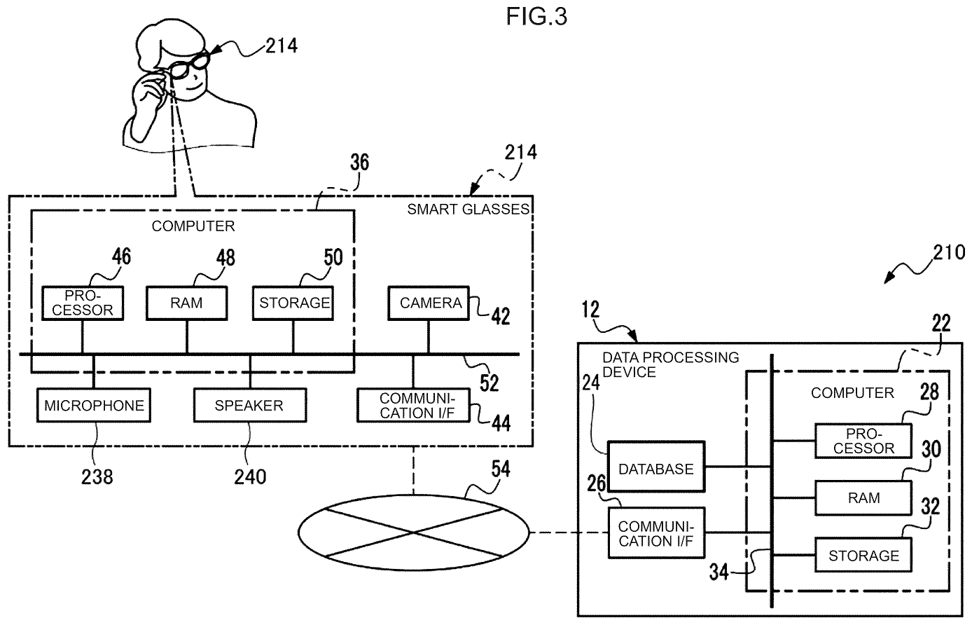

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

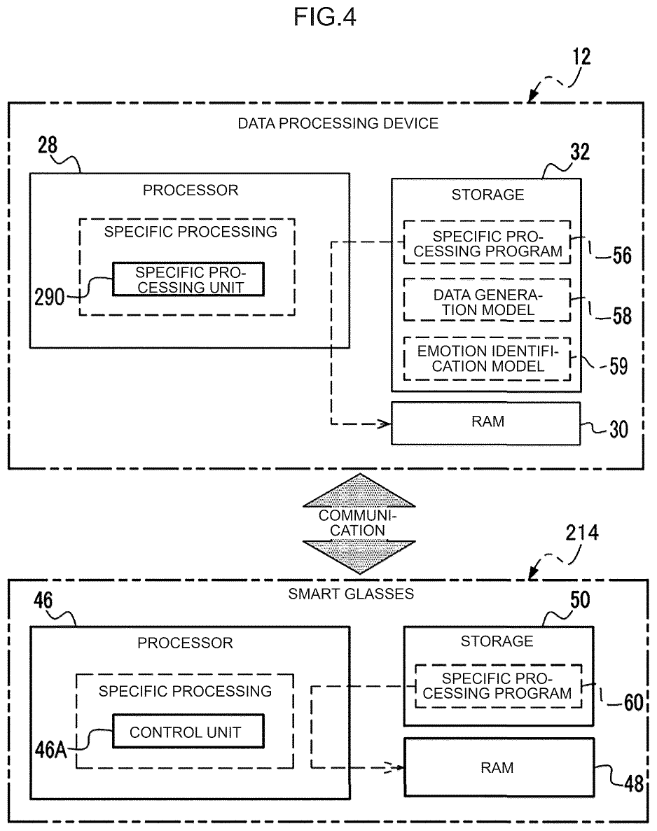

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described data collection unit, preference analysis unit, news collection unit, newsletter generation unit, and newsletter provision unit may be implemented by at least one of, for example, smart glasses 214 and a data processing apparatus 12. For example, the data collection unit may be implemented by a control unit 46A of the smart glasses 214 and collect the user's browsing history, search history, and activity data on social media. The preference analysis unit may be implemented by, for example, a specific processing unit 290 of the data processing apparatus 12 and analyze the collected data to identify user preferences and interests. The news collection unit may be implemented by, for example, the specific processing unit 290 of the data processing apparatus 12 and collect the latest information from news sites, blogs, or social media on the Internet. The newsletter generation unit may be implemented by, for example, the specific processing unit 290 of the data processing apparatus 12 and create a customized newsletter based on the collected news or articles. The newsletter provision unit may be implemented by, for example, the control unit 46A of the smart glasses 214 and provide the generated newsletter to the user. The correspondence between each unit and the apparatus or control unit is not limited to the above examples and various modifications are possible.

### Third Embodiment

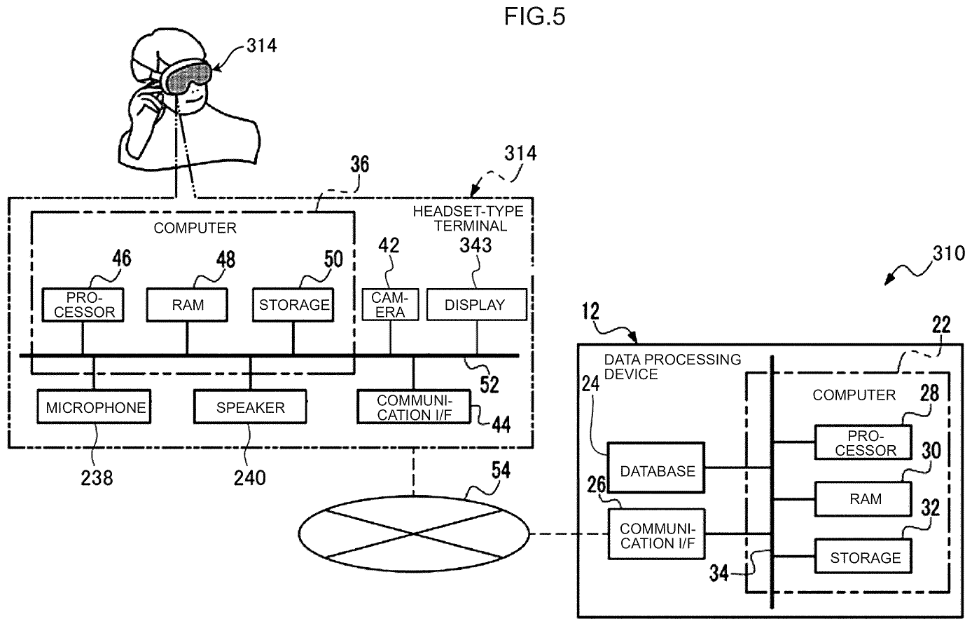

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

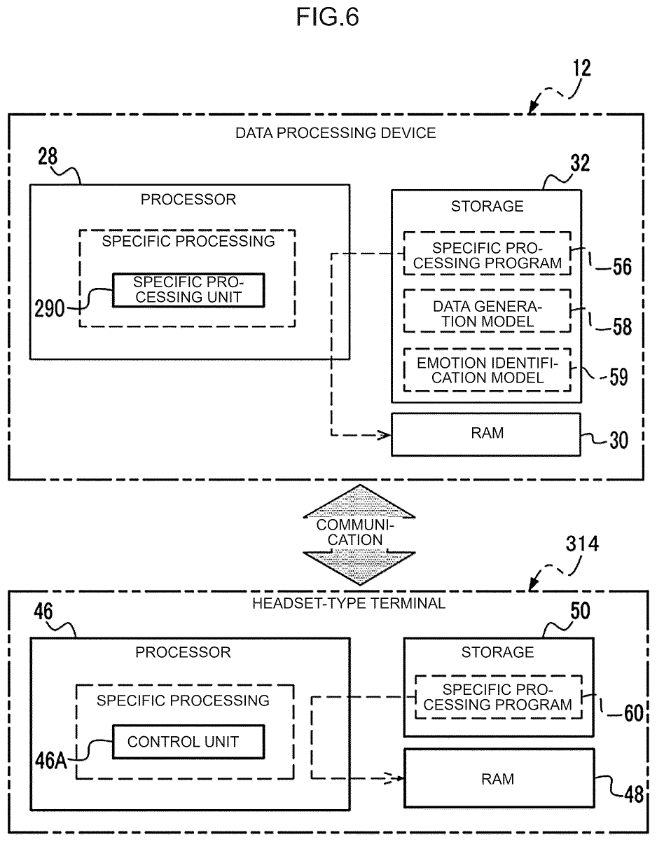

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described data collection unit, preference analysis unit, news collection unit, newsletter generation unit, and newsletter provision unit may be implemented by at least one of, for example, a headset-type terminal 314 and a data processing apparatus 12. For example, the data collection unit may be implemented by a control unit 46A of the headset-type terminal 314 and collect the user's browsing history, search history, and activity data on social media. The preference analysis unit may be implemented by, for example, a specific processing unit 290 of the data processing apparatus 12 and analyze the collected data to identify user preferences and interests. The news collection unit may be implemented by, for example, the specific processing unit 290 of the data processing apparatus 12 and collect the latest information from news sites, blogs, or social media on the Internet. The newsletter generation unit may be implemented by, for example, the specific processing unit 290 of the data processing apparatus 12 and create a customized newsletter based on the collected news or articles. The newsletter provision unit may be implemented by, for example, the control unit 46A of the headset-type terminal 314 and provide the generated newsletter to the user. The correspondence between each unit and the apparatus or control unit is not limited to the above examples and various modifications are possible.

### Fourth Embodiment

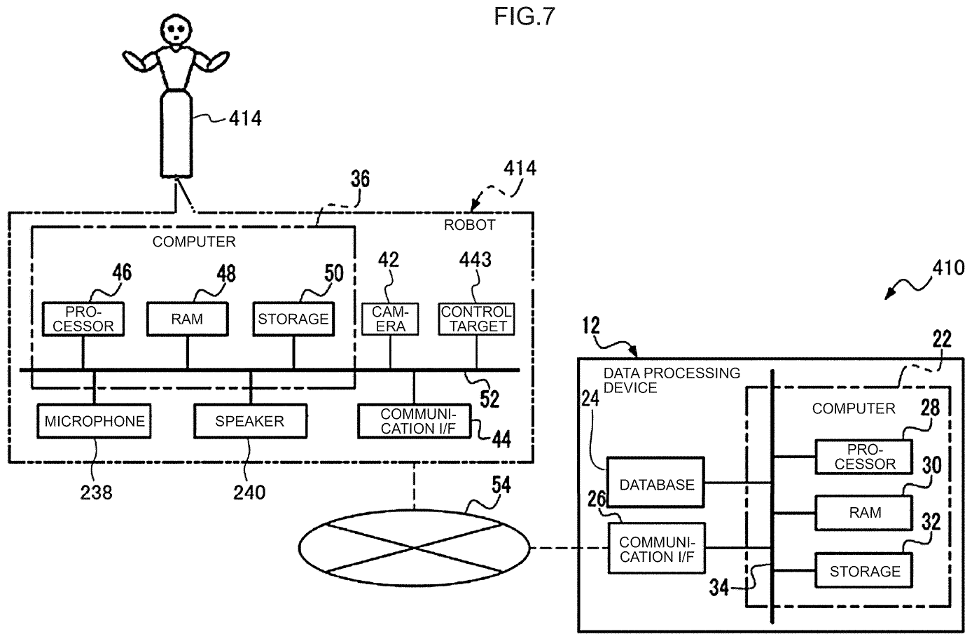

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

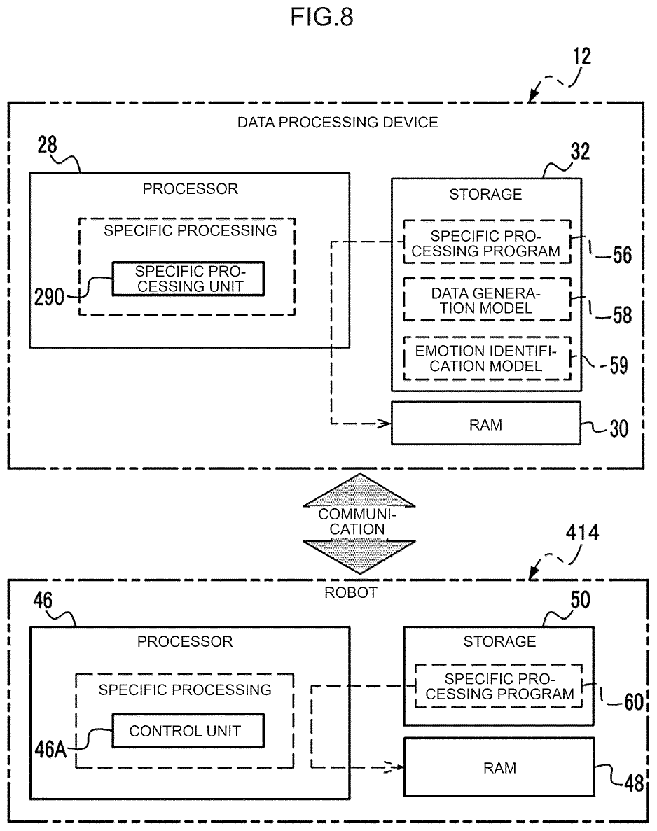

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described data collection unit, preference analysis unit, news collection unit, newsletter generation unit, and newsletter provision unit may be implemented by at least one of, for example, a robot 414 and a data processing apparatus 12. For example, the data collection unit may be implemented by a control unit 46A of the robot 414 and collect the user's browsing history, search history, and activity data on social media. The preference analysis unit may be implemented by, for example, a specific processing unit 290 of the data processing apparatus 12 and analyze the collected data to identify user preferences and interests. The news collection unit may be implemented by, for example, the specific processing unit 290 of the data processing apparatus 12 and collect the latest information from news sites, blogs, or social media on the Internet. The newsletter generation unit may be implemented by, for example, the specific processing unit 290 of the data processing apparatus 12 and create a customized newsletter based on the collected news or articles. The newsletter provision unit may be implemented by, for example, the control unit 46A of the robot 414 and provide the generated newsletter to the user. The correspondence between each unit and the apparatus or control unit is not limited to the above examples and various modifications are possible.

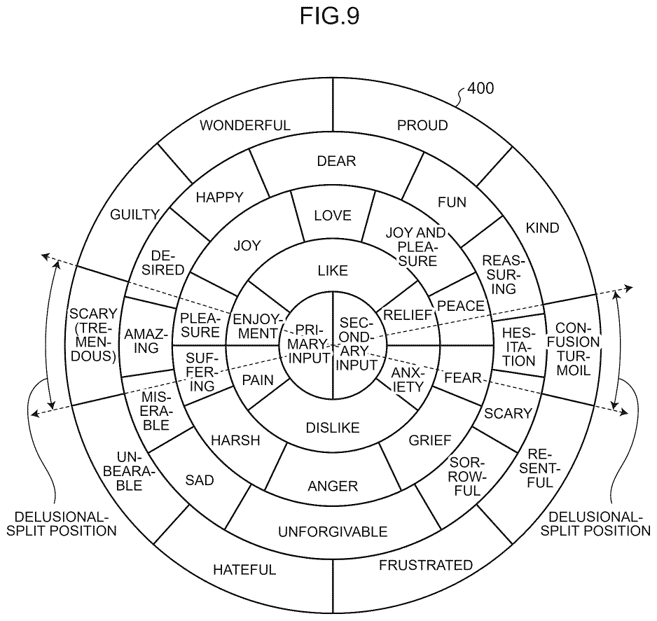

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

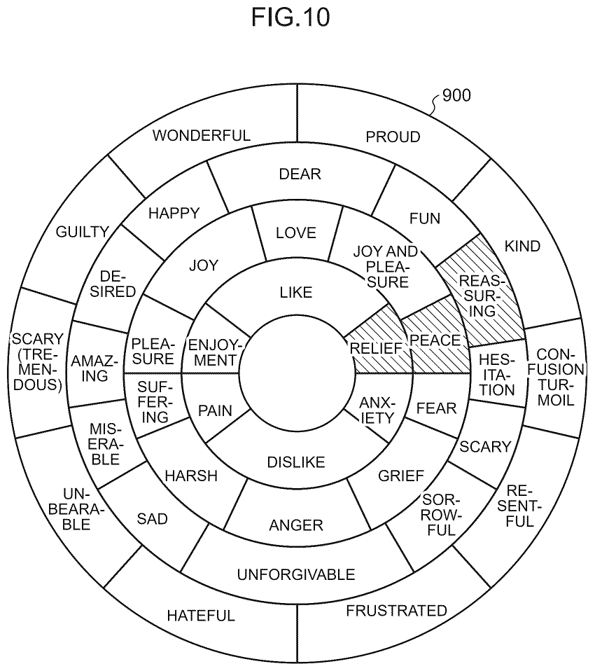

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1)A system comprising: a data collection unit configured to collect user data; a preference analysis unit configured to analyze the data collected by the data collection unit and to identify user preferences and interests; a news collection unit configured to collect news or articles based on the user's interests obtained by the preference analysis unit; a newsletter generation unit configured to create a customized newsletter based on the news or articles collected by the news collection unit; and a newsletter provision unit configured to provide the newsletter generated by the newsletter generation unit to the user.
(Supplementary Note 2)The system according to Supplementary Note 1, wherein the data collection unit is configured to collect a user's past browsing history, search history, and activity data on social media.
(Supplementary Note 3)The system according to Supplementary Note 1, wherein the preference analysis unit is configured to analyze the data collected by the data collection unit and to identify the user's interests.
(Supplementary Note 4)The system according to Supplementary Note 1, wherein the news collection unit is configured to collect the latest information from news sites, blogs, or social media on the Internet.
(Supplementary Note 5)The system according to Supplementary Note 1, wherein the newsletter generation unit is configured to select articles that match the user's interests and summarize them using expressions that attract the user's attention.
(Supplementary Note 6)The system according to Supplementary Note 1, wherein the newsletter provision unit is configured to provide the generated newsletter to the user and include links to the original articles.
(Supplementary Note 7)The system according to Supplementary Note 1, wherein the data collection unit is configured to estimate the user's emotions and adjust the timing of data collection based on the estimated emotions.
(Supplementary Note 8)The system according to Supplementary Note 1, wherein the data collection unit is configured to analyze the user's past data collection history and select an appropriate collection method.
(Supplementary Note 9)The system according to Supplementary Note 1, wherein the data collection unit is configured to perform filtering during data collection based on the user's current interests and activity status.
(Supplementary Note 10)The system according to Supplementary Note 1, wherein the data collection unit is configured to estimate the user's emotions and determine the priority of data to be collected based on the estimated emotions.
(Supplementary Note 11)The system according to Supplementary Note 1, wherein the data collection unit is configured to preferentially collect highly relevant data during data collection by considering the user's geographic location information.
(Supplementary Note 12)The system according to Supplementary Note 1, wherein the data collection unit is configured to analyze the user's social media activity during data collection and collect relevant data.
(Supplementary Note 13)The system according to Supplementary Note 1, wherein the preference analysis unit is configured to estimate the user's emotions and adjust the method of preference analysis based on the estimated emotions.
(Supplementary Note 14)The system according to Supplementary Note 1, wherein the preference analysis unit is configured to appropriately adjust the analysis algorithm by referring to the user's past preference data during preference analysis.
(Supplementary Note 15)The system according to Supplementary Note 1, wherein the preference analysis unit is configured to track changes in the user's interests in real time during preference analysis and update the analysis results.
(Supplementary Note 16)The system according to Supplementary Note 1, wherein the preference analysis unit is configured to estimate the user's emotions and determine the priority of preference analysis based on the estimated emotions.
(Supplementary Note 17)The system according to Supplementary Note 1, wherein the preference analysis unit is configured to perform analysis during preference analysis by considering the user's geographic location information.
(Supplementary Note 18)The system according to Supplementary Note 1, wherein the preference analysis unit is configured to improve the accuracy of analysis by referring to the user's social media activity during preference analysis.
(Supplementary Note 19)The system according to Supplementary Note 1, wherein the news collection unit is configured to estimate the user's emotions and adjust the method of news collection based on the estimated emotions.
(Supplementary Note 20)The system according to Supplementary Note 1, wherein the news collection unit is configured to appropriately adjust the collection algorithm by referring to the user's past news browsing history during news collection.
(Supplementary Note 21)The system according to Supplementary Note 1, wherein the news collection unit is configured to track changes in the user's interests in real time during news collection and update the collection results.
(Supplementary Note 22)The system according to Supplementary Note 1, wherein the news collection unit is configured to estimate the user's emotions and determine the priority of news to be collected based on the estimated emotions.
(Supplementary Note 23)The system according to Supplementary Note 1, wherein the news collection unit is configured to preferentially collect highly relevant news during news collection by considering the user's geographic location information.
(Supplementary Note 24)The system according to Supplementary Note 1, wherein the news collection unit is configured to improve the accuracy of collection by referring to the user's social media activity during news collection.
(Supplementary Note 25)The system according to Supplementary Note 1, wherein the newsletter generation unit is configured to estimate the user's emotions and adjust the method of expression of the newsletter based on the estimated emotions.
(Supplementary Note 26)The system according to Supplementary Note 1, wherein the newsletter generation unit is configured to appropriately adjust the level of detail of the newsletter during newsletter generation based on the user's interests.
(Supplementary Note 27)The system according to Supplementary Note 1, wherein the newsletter generation unit is configured to apply different generation algorithms during newsletter generation according to the category of the user's interests.
(Supplementary Note 28)The system according to Supplementary Note 1, wherein the newsletter generation unit is configured to estimate the user's emotions and adjust the length of the newsletter based on the estimated emotions.
(Supplementary Note 29)The system according to Supplementary Note 1, wherein the newsletter generation unit is configured to determine the priority of the newsletter during newsletter generation based on the submission timing of the user's interests.
(Supplementary Note 30)The system according to Supplementary Note 1, wherein the newsletter generation unit is configured to adjust the order of the newsletter during newsletter generation based on the relevance of the user's interests.
(Supplementary Note 31)The system according to Supplementary Note 1, wherein the newsletter provision unit is configured to estimate the user's emotions and adjust the method of providing the newsletter based on the estimated emotions.
(Supplementary Note 32)The system according to Supplementary Note 1, wherein the newsletter provision unit is configured to select an optimal provision method by referring to the user's past newsletter browsing history during newsletter provision.
(Supplementary Note 33)The system according to Supplementary Note 1, wherein the newsletter provision unit is configured to track changes in the user's interests in real time during newsletter provision and update the provision results.
(Supplementary Note 34)The system according to Supplementary Note 1, wherein the newsletter provision unit is configured to estimate the user's emotions and adjust the frequency of providing the newsletter based on the estimated emotions.
(Supplementary Note 35)The system according to Supplementary Note 1, wherein the newsletter provision unit is configured to select an appropriate provision method during newsletter provision by considering the user's geographic location information.
(Supplementary Note 36)The system according to Supplementary Note 1, wherein the newsletter provision unit is configured to improve the accuracy of provision by referring to the user's social media activity during newsletter provision.

What is claimed is:

1. A system comprising:
a processor;
a memory coupled to the processor;
a storage storing instructions and a trained classification model;
a database; and
a communication interface coupled to a network,
wherein the processor executes the instructions stored in the storage to cause the system to:
collect, via the communication interface, user data from a client terminal, the user data including at least one of browsing history, search history, or social media activity data;
analyze the collected user data by applying the trained classification model to generate a preference profile identifying user interests as a category score distribution;
collect, based on the preference profile, news articles from one or more external sources via the network, and filter the collected news articles based on the category score distribution;
generate a personalized newsletter by applying a summarization model to the filtered news articles to produce summary content including modified titles and lead text;
and transmit the personalized newsletter to the client terminal via the communication interface, the newsletter including links to original articles.

2. The system according to claim 1,
wherein the user data comprises a browsing history tensor representing browsing data over a predetermined time period, a search keyword vector, and a social media activity text array.

3. The system according to claim 1,
wherein the trained classification model comprises a Transformer-based language model that concatenates browsing history, search keyword vectors, and social media embedding vectors at an input layer and generates the category score distribution at an output layer.

4. The system according to claim 1,
wherein collecting news articles comprises obtaining article data in a structured format including title, body, publication date, source, and category label from news sites via web scraping or RSS feed APIs.

5. The system according to claim 1,
wherein the summarization model comprises an Encoder-Decoder Transformer architecture.

6. The system according to claim 1,
wherein transmitting the personalized newsletter comprises selecting a delivery channel from a plurality of delivery channels based on the user's past browsing history and device usage pattern.

7. The system according to claim 1,
wherein the storage further stores an emotion identification model, and
wherein the processor is further configured to estimate a user emotion by applying the emotion identification model to at least one of facial image data, audio data, or text data received from the client terminal, and adjust timing of collecting the user data based on the estimated user emotion.

8. The system according to claim 7,
wherein estimating the user emotion comprises:
encoding facial image data using a convolutional neural network;
extracting emotion features from audio data using a spectrogram and a recurrent neural network; and
converting text data to emotion embedding vectors using a pretrained language model,
and integrating the encoded facial image data, the extracted emotion features, and the emotion embedding vectors using a multimodal emotion estimation model.

9. The system according to claim 1,
wherein the processor is further configured to analyze a past data collection history for the user and select an appropriate collection method based on the past data collection history.

10. The system according to claim 1,
wherein the processor is further configured to filter the user data during collection based on a current interest state and activity status of the user.

11. The system according to claim 1,
wherein the processor is further configured to preferentially collect user data associated with a geographic region of the user based on geographic location information received from the client terminal.

12. The system according to claim 1,
wherein the processor is further configured to adjust analysis parameters of the trained classification model by referring to past preference data for the user.

13. The system according to claim 1,
wherein the processor is further configured to track changes in user interests in real time and update the preference profile based on detected changes.

14. The system according to claim 1,
wherein the processor is further configured to evaluate reliability of the collected news articles based on at least one of a source reliability score, author history, or a fake news detection model output, and exclude articles with reliability below a threshold.

15. The system according to claim 1,
wherein generating the personalized newsletter further comprises applying a natural language generation module to add lead sentences including emotional expressions to the summary content.

16. The system according to claim 1,
wherein the processor is further configured to dynamically adjust a layout of the personalized newsletter based on the preference profile, selecting between a visual content layout and a text-centric layout based on user content format preferences.

17. The system according to claim 1,
wherein the processor is further configured to collect behavioral log data including articles clicked by the user and opening times after transmitting the personalized newsletter, and use the behavioral log data to update the trained classification model for a subsequent iteration.

18. A system comprising:
a processor comprising at least one of a CPU, a GPU, or a TPU;
a RAM coupled to the processor;
a non-volatile storage storing a specific processing program, a data generation model obtained by deep learning on a neural network, and an emotion identification model;
a database;
a communication interface connected to a network comprising at least one of a WAN or a LAN; and circuitry configured to:
collect, via the communication interface from a client terminal, user data including a browsing history tensor, a search keyword vector, and a social media activity text array;
apply a Transformer-based classification model to the collected user data to generate a category score distribution representing user interests;
collect news article data in a structured format from external sources via web scraping or RSS feed APIs, and filter the news article data by extracting articles having category scores above a threshold;
generate a personalized newsletter by inputting filtered article bodies to an Encoder-Decoder Transformer summarization model to produce summary titles and summary body text;
estimate a user emotion by applying the emotion identification model to at least one of facial image data, audio data, or text data received from the client terminal; and
transmit the personalized newsletter to the client terminal, the newsletter including URL links or QR codes to original articles, wherein a delivery channel and delivery timing are determined based on the estimated user emotion and past user click history.

19. The system according to claim 18,
wherein the data generation model comprises at least one of a text generation AI, an image generation AI, or a multimodal generation AI, and
wherein the data generation model is a fine-tuned model configured to output inference results from prompts without instructions.

20. A method performed by a system comprising a processor, a memory, a storage, a database, and a communication interface, the method comprising:
collecting, via the communication interface, user data from a client terminal, the user data including at least one of browsing history, search history, or social media activity data;
analyzing the collected user data by applying a trained classification model stored in the storage to generate a preference profile identifying user interests as a category score distribution;
collecting, based on the preference profile, news articles from one or more external sources via the communication interface, and filtering the collected news articles based on the category score distribution;
generating a personalized newsletter by applying a summarization model to the filtered news articles to produce summary content including modified titles and lead text; and
transmitting the personalized newsletter to the client terminal via the communication interface, the newsletter including links to original articles.
